(19) United States
(12) Patent Application Publication
(10) Pub. No.: US 2026/0364825 A1
(43) Pub. Date: Nov. 19, 2026

(54) JOINT MECHANISM

(71) Applicant: Allonic Inc., Wilmington, DE (US)

(72) Inventors: Benedek József Tasi, Budapest (HU); Dávid László Pelyva, Budapest (HU); Dávid Holló, Budapest (HU)

(21) Appl. No.: 19/676,641

(22) Filed: May 13, 2026

(30) Foreign Application Priority Data
May 13, 2025 (HU) P2500156

(51) Int. Cl. B25J 17/02; B25J 9/10

(52) U.S. Cl. CPC B25J 17/0241; B25J 9/104

(57) ABSTRACT

A joint mechanism is disclosed comprising a braided ligament system that mechanically couples articulatable terminals of one or more joints. The braided ligament system exhibits longitudinal-to-radial strain coupling such that tensile loading of the braided structure generates radial compression against surfaces of one or more terminals to establish a self-supporting mechanical engagement therewith. The engagement may comprise positive-locking press-fit engagement, friction-fit engagement, or a combination thereof, anchoring the braided ligament system to at least one terminal with respect to one or more degrees of freedom. The braided ligament system permits relative movement between terminals while constraining displacement in predetermined directions, thereby providing structural coupling, load transfer, and motion-limiting functionality.

### RELATED APPLICATIONS

This application claims the benefit of priority under 35 U.S.C. 119 to Hungarian Patent Application No. P2500156, filed May 13, 2025, the entire contents of which are incorporated herein by reference.

### TECHNICAL FIELD

The present disclosure relates generally to mechanical joints. More particularly, the present disclosure relates to mechanical joints with fiber ligament systems. Even more particular embodiments relate to biomimetic joints with fiber ligament systems.

### BACKGROUND

In recent decades, biomimetics as an engineering design approach has become increasingly important, in particular in the design of moving and actuating systems and in addressing the challenges posed by robotics and biomechanics. Mechanical modelling of the musculoskeletal mechanisms of vertebrate living organisms at various levels of abstraction serves well in applications where an engineering reproduction of natural motion and the associated adaptive, often highly efficient behavior is required. Such applications may include, for example, the development of humanoid robots, walking legs, aerial vehicles and manipulators, and, in the field of healthcare, the design of orthoses, prostheses and bionic implants.

Biological systems formed over millions of years of evolution have been optimized to an extremely high level according to species-specific functions, adapting to natural living conditions and challenges. As a result, individual animal and human body parts—such as the human hand, the spine, and animal limbs promoting different lifestyles—exhibit a robust yet flexible and functionally optimized structure. Biological joints not only serve to provide movement, but are also, in a structurally complex manner, capable of dynamically varying stiffness, direction-dependent limitation of movement and finely tuned mechanical responses.

Currently widespread engineering models are able to reproduce this complexity only in part. They are typically characterized by function-centered abstraction: the motion of joints is often approximated along well-defined axes, with rigid attachment points and simple geometries, for example by means of hinges, ball-and-socket joints and gimbals, relying solely on their rigid end stops to define ranges of motion. While such solutions can successfully map the basic operation and movement ranges of joints, due to their simplifications and the lack of a ligament system, they cannot reproduce the nature of fine motor coordination, adaptive stiffness, the dynamic harmony of active and passive mechanisms, and the resulting natural sense of movement found in natural joints. For example, the metacarpophalangeal joint of the hand is often modelled by a structure movable about two mutually perpendicular axes, which does provide basic flexion and lateral movements, but in itself does not allow axial rotation and the stiffness variation associated with movement. Similarly, the trapezio-metacarpal joint of the thumb is often replaced by a ball-and-socket joint, although, in anatomical reality, the axes of movement of the joint do not intersect, resulting in significantly different movement characteristics. Similarly, owing to the twisting of its saddle surfaces, automatic axial rotation occurs about a virtual axis formed significantly outside the boundaries of the joint, which is particularly difficult to implement using conventional methods.

The operation of natural joints is jointly determined by the geometric shape of the articular surfaces, the points of origin and insertion of ligaments, their branching, and the extensibility or local stiffness of the tissues. Even minor variations in the lines of force and paths defined by muscles and tendons may significantly influence the mechanical behavior of a joint. These anatomical and functional details are not merely passive elements but play an active role in regulating the quality and efficiency of movement. This complex functional influence demonstrates that, in order to reproduce biomechanical functions in a precise and detailed manner that ensures natural motion characteristics and adaptability, and that functionally go beyond engineering solutions currently in widespread use, appropriate mechanical implementation of structural and functional anatomical details is indispensable. For industrial and medical applications, it is additionally necessary to ensure sufficient robustness, reliability and durability, as well as scalable manufacturability.

In recent years, a number of highly biomimetic robotic solutions have been disclosed with the aim of reproducing anatomical joint organization as accurately as possible. These developments are often based on data derived from medical imaging or on direct anatomical models, or alternatively on engineer-designed biomimetic geometric structures, and seek to provide a detailed mechanical mapping of the operation of biological joints. Examples include finger models published by Zhe Xu et al. and Yiming Zhu et al., which, although carrying many biomorphic features, also have several technical limitations.

The authors of Y. Zhu, G. Wei, L. Ren, Z. Luo and J. Shang, “An Anthropomorphic Robotic Finger With Innate Human-Finger-Like Biomechanical Advantages Part I: Design, Ligamentous Joint, and Extensor Mechanism,” in IEEE Transactions on Robotics, vol. 39, no. 1, pp. 485-504, February 2023 developed a modular mechanical finger comprising various 3D-printed skeletal elements, crocheted textile ligaments and a joint capsule made of silicone. In the design of the system, the ligaments are attached to steel rings, which are then fixed to the bone structure by means of screws or adhesive bonding. Although this construction allows partial biomimetic reproduction of the range and character of movement, the connection between the ligament and the bone is not integrated but is realized by multi-step assembly using external fastening elements. The point-like load zones formed during sewing and screwing may lead to weakening of the material structure, local overloading and, in the long term, fatigue damage. The assembly process is complex, time-consuming and difficult to automate, rendering the solution poorly suited for industrial manufacture, in particular for series production. The ligament structure is functionally separated from the bone structure, and no materially bonded, self-supporting connection is formed that would provide the integrity characteristic of natural ligament systems.

Similar limitations characterize the anthropomorphic finger structure of Zhu, Yiming & Wei, Guowu & Ren, Lei & Luo, Zirong & Shang, Jianzhong. (2022). An Anthropomorphic Robotic Finger With Innate Human-Finger-Like Biomechanical Advantages Part I: Design, Ligamentous Joint, and Extensor Mechanism. IEEE Transactions on Robotics. PP. 1-20. 10.1109/TRO.2022.3200006, which comprises ligaments braided from PET fibers, a joint capsule made of silicone, and tendons for actuation purposes. Although the system imitates, to a certain extent, the movement characteristics of human finger joints, the ligament system in this case likewise does not form a continuous, self-supporting sheath. The ligaments are not attached to the surfaces of the terminals in a clamping, positive-locking manner, but are connected to the structure by subsequent installation using mechanical fastening, fusion or adhesive bonding. As a consequence, strong and durable material-structural integration between the ligament and the bone surface is not achieved; instead, the terminals are subjected to point loads at each individual fastening location. The assembly steps are multi-stage, and fitting errors and irregularities arising during assembly, as well as the very nature of point-like fixation, may result in mechanical weak points that impair service life and operational stability. Furthermore, the design method and the base materials used for the ligament system, such as braided ropes, significantly limit the possibilities available for configuring the system, for example with respect to complex three-dimensional structures. The ligament and the capsule are produced using separate manufacturing technologies, and their interaction is not structurally defined, but is instead established by subsequent assembly.

Also disclosed by Zhe Xu and E. Todorov, “Design of a highly biomimetic anthropomorphic robotic hand towards artificial limb regeneration,” 2016 IEEE International Conference on Robotics and Automation (ICRA), Stockholm, Sweden, 2016, pp. 3485-3492, doi: 10.1109/ICRA.2016.7487528, is a 3D-printed finger skeleton employing crocheted textile ligaments and a laser-cut, silicone-based outer capsule. The ligaments are produced by crocheting and subsequently fixed to the base structure by screwing. The aim of the design is to reproduce natural joint operation, with particular regard to the physiology of the hand. Although certain elements of the construction are, in themselves, remarkably detailed, the fastening solutions are in this case likewise realized by the use of separate components and subsequent assembly operations. The connection between the ligament and the bone is not structurally integrated, and therefore the mechanical response of the system is not uniform; due to point-like load introduction, its strength and durability are limited. In a structure assembled from multiple materials and discrete components, the movement trajectories and stiffness characteristics are not determined by the material configuration itself but depend solely on the accuracy of the joints and of individual components, such as hand-made elements in the case of crocheting and may therefore exhibit considerable variation during operation.

Accordingly, these solutions reproduce biological structures with varying degrees of success, but none of them is capable of implementing material-structural and functional integration of the joint capsule and the ligament system in a form that would also meet the requirements of industrial manufacturability, durability and simplified assembly. Accordingly, improved joint mechanisms are desired.

### SUMMARY OF THE DISCLOSURE

As discussed, there is a need for improved joint mechanisms that eliminate one or more disadvantages of the prior systems, with particular regard to the reliability of fixation between the ligament and the terminal, the functional integrity of the structure, and the feasibility of industrial series manufacture. According to one aspect of the present disclosure, the aforementioned technical objectives are achieved by a joint mechanism comprising at least two terminals configured for relative motion and a ligament system defined by a braided-structure sheath coupling said terminals. The configuration of the ligament system enables it to be fixed to at least one of the terminals in a self-securing manner without the need, in some embodiments, for secondary fastening elements or post-fabrication assembly steps. As a result, structural weak points, material damage and fitting inaccuracies arising from conventional assembly methods can be avoided, while production speed can be significantly increased. The construction of structures the assembly of which otherwise would not be possible due to their complex, interlacing geometry, is also made possible. Further, some embodiments may employ secondary clamping mechanisms such as a clamping ring that seats in a groove or other indent or other elements to provide auxiliary fixation.

The elements functioning as ligaments may be formed as part of a braided sheath and form a functionally and mechanically integrated unit with the terminals. In certain embodiments, a ligament system can be produced in a single operation by braiding directly onto the terminals in-situ, thereby enabling the formation of a post fabrication assembly-free, structurally uniform joint. The braided sheath may further carry additional functional properties by guiding motion, controlling elastic deformations or integrating additional elements (such as actuating or force-transmission elements, or sensors) as part of a unified structure. Further, as a continuous textile structure, the braided ligament system may facilitate implementation of chains or networks of multiple joints and complex actuation systems.

The present disclosure thus relates to joint mechanisms for articulating structures and, more particularly, to joint mechanisms in which a plurality of terminals, which may be rigid members in some embodiments, are mechanically coupled by a braided textile ligament system.

According to one aspect, a joint mechanism comprises a plurality of terminals adapted to move relative to one another and a ligament system formed as a braided structure sheath that couples the terminals. In at least one operating state of the joint mechanism,-the ligament system establishes a mechanical engagement with a surface of at least one terminal by a self clamping effect of the braided structure to fix the ligament structure to the at least terminal.-In some embodiments, the mechanical engagement established through the self clamping effect comprises at least one of a positively locking form-fit engagement or a-friction locking engagement. Through the self-clamping effect, the ligament system may establish such mechanical engagement with the surfaces of two or more terminals, and in certain embodiments to each of the plurality of terminals. Further, in some embodiments, fixing elements may be used to enhance form-fit fixation or auxiliary elements such as clamping rings or fasteners may be used to provide auxiliary fixation.

In some embodiments, one or more terminals include a shaped surface configuration that promotes fixation of the ligament system, such as a groove, a textured or roughed surface (e.g., a knurled surface or other surface engineered to have an increased roughness (Ra) value), or a tapered surface. The braided ligament system may be configured such that an inclination angle of braided fibers decreases under load, causing radial contraction of the braided structure sheath and an increase in clamping force.

The ligament system may include multiple regions having different braiding densities, fiber patterns, compactness, or fiber materials, enabling regional differentiation of mechanical properties. In some embodiments, the ligament system comprises one or more ligament parts having at least one ligament branch or strap portion in regions permitting relative displacement between terminals. Rigid, flexible, or elastic inserts may be incorporated into the ligament system to influence mechanical or functional properties.

The ligament system may further include one or more guiding parts integrated into the braided structure, such as loops or feed through openings, for passage of coupling elements or ligament portions. In some embodiments,-a coupling element is configured as a tendon forming part of the ligament system and is adapted to actuate relative movement of the terminals or to couple the joint mechanism to an external object. Similar to the ligaments, such tendons may also comprise elaborate branching geometries or additional elements to realize advanced mechanical functionality.

In certain embodiments, the ligament system is formed in a single braiding operation by direct or indirect braiding onto the terminals and may include biaxial, triaxial, or multi directional braiding geometries. The ligament system may be formed of mutually interwoven braided-fibers. The fibers may be composed of materials from various classes including, but not limited to, polymeric materials such as aramids, polyesters, polyamides, or polyethylenes (e.g., ultra-high-molecular-weight polyethylene (UHMWPE)); thermoplastic or elastomeric materials such as elastomer-based polymers; metallic materials including metallic wires or filaments; mineral-based fibers; carbon fibers; glass fibers; natural fibers; or other types of fibers. Various types of fibers may be used alone or in combination. The fibers may be provided in various structural forms, including monofilaments or multifilaments. Furthermore, the ligament system 20 may be configured as a multi layered braided structure comprising, for example, a plurality of concentric or integrated braided-layers.

In some embodiments, the self clamping effect of the braided ligament system increases as a function of mechanical load applied-to the joint mechanism. The ligament system may mechanically couple the terminals without requiring post fabrication fastening elements, adhesive bonding, or sutures, and may distribute mechanical loads-over extended surface areas of the terminals rather than through discrete point like attachment locations. Optional fixing elements or auxiliary fixation elements may be provided-in some embodiments to enhance or supplement fixation.

One general aspect of the present disclosure includes a joint mechanism having at least two terminals capable of displacement relative to each other. The joint mechanism comprises a braided ligament system interconnecting the terminals, where the braided ligament system is designed as a braided sleeve circumferentially surrounding the surface of at least one terminal in a sheath-like manner and fitting in a form-locking manner to the at least one terminal.

Embodiments of this aspect may include one or more of the following features. The ligament system comprises a braided sleeve surrounding the surface of several terminals in a sheath-like manner and fitting in a form-locking manner to the given terminals. On at least one terminal, a shaped surface configuration containing a recess, step, or surface profile change limiting the axial displacement of the ligament system is formed. The shaped surface configuration may include a groove running circumferentially on the surface of the terminal, a roughed surface, or a conical surface. The ligament system is designed with different braiding density and/or pattern in one or more regions and/or with fibers of different materials. The ligament system comprises, in a section providing the range of motion between the terminals a ligament part formed with at least one ligament branch. The ligament system comprises, in the section providing the range of motion between the terminals a ligament part formed with at least two ligament branches branching from each other. The joint mechanism comprises a rigid, flexible, or elastic insert integrated into the ligament system, into its braided structure, influencing the mechanical or functional properties of is installed. The joint mechanism characterized in that the ligament system may include at least one guiding part designed as a loop or a feed-through opening providing the feed-through of a ligament part, wherein the guiding part may form a structural part of the braided structure of the ligament system. The joint mechanism characterized in that a coupling element designed as a tendon forming part of the ligament system is fed through the guiding part. The joint mechanism characterized in that the ligament system is over-braided onto the terminals. The joint mechanism wherein the ligament system is designed with biaxial, triaxial, or multi-directional braiding geometry. The joint mechanism, wherein the ligament system may include thermoplastic, elastomer, or composite fibers. The joint mechanism, wherein the ligament system is fastened to at least one surface of the terminals by means of a fastening element fitting into a fastening cavity formed on the terminal. The joint mechanism characterized in that it may include several braided ligament systems arranged in layers on each other, surrounding the terminals in a sheath-like manner.

In some embodiments, the braided ligament system provides passive motion constraint, such that stiffness of the articulated robotic structure increases as a joint approaches an end-of-range condition. In other embodiments, different regions of the ligament system provide asymmetric or direction-dependent resistance, enabling non-uniform joint behavior analogous to biological joints.

Embodiments may be particularly suitable for robotic, biomechanical, or orthotic applications requiring natural-joint-like mechanical behavior, integrated structural design, high holding force with flexibility, and soft conformability.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagrammatic representation of one embodiment of a joint mechanism.

FIG. 2 illustrates one embodiment of a joint mechanism.

FIG. 3 is a side view of the embodiment of FIG. 2 illustrating the connection of base bodies to the terminals in accordance with one embodiment.

FIG. 4 is a longitudinal section view of the embodiment of FIG. 2 in accordance with one embodiment.

FIG. 5 illustrates one embodiment of a ligament system and terminals of the embodiment of FIG. 2.

FIG. 6 illustrates the ligament system of FIG. 5 with the addition of clamping rings in accordance with one embodiment.

FIG. 7 is an end view of one embodiment of a ligament system and terminal.

FIG. 8 is a second end view of one embodiment of a ligament system and terminals.

FIG. 9A, FIG. 9B and FIG. 9C illustrate the embodiment of FIG. 2 in various states (extended, partially bent, fully bent) in accordance with one embodiment.

FIG. 10 illustrates a side view of another embodiment of a joint mechanism for a humanoid knee joint.

FIG. 11 is a sectional view of the embodiment of FIG. 10.

FIG. 12 illustrates one embodiment of a joint mechanism with a multi-layer ligament system.

FIG. 13 illustrates a side view of another embodiment of a joint mechanism.

FIG. 14 is a sectional view of the embodiment of FIG. 12.

FIG. 15A and FIG. 15B illustrate one embodiment of a joint mechanism with a multi-layer ligament system for a chain of joints.

FIG. 16 illustrates one embodiment of a robotic humanoid finger.

FIG. 17 illustrates a robotic humanoid finger connected to an actuator in accordance with one embodiment.

FIG. 18A, FIG. 18B and FIG. 18C illustrate various embodiments of structures that may be formed on the ligament systems to facilitate attachment of external bodies.

FIG. 19A illustrates one embodiment of a method of manufacturing a joint mechanism.

FIG. 19B illustrates one embodiment of supporting a mandrel in the method of FIG. 19A.

FIG. 20 illustrates one embodiment of a braiding system.

FIG. 21A, FIG. 21B and FIG. 21C illustrates one embodiment of a braiding system over-braiding a mandrel.

FIG. 22 illustrates another embodiment of a braiding system.

FIG. 23 illustrates one embodiment of a robotic finger.

FIG. 24 illustrates one embodiment of a robotic hand.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Each feature or element described herein is intended to be independent of other features and elements unless a functional dependency is explicitly stated. Accordingly, any individual feature, component, or sub-assembly may be combined with any other features or components described elsewhere in this specification, regardless of the specific embodiment in which they were first introduced. The applicant intends for this disclosure to support any such sub-combination or intermediate configuration as part of this disclosure.

References to ‘radial,’ ‘annular,’ or ‘circumferential’ dimensions or forces are intended to describe relative orientations and do not require a circular cross-section unless explicitly stated. For example, “radial,” “annular,” and “circumferential” are used to describe directions or distributions with respect to a local perimeter-defined reference frame of a component and are intended to include circular and non-circular perimeter geometries. Further, a “ring” or “sleeve” does not require a circular cross-section unless explicitly stated.

The inventors recognized that the greatest challenge of joint mechanisms according to the state of the art lies in the efficient yet structurally and mechanically integrated fixation of components made of different materials, such as a rigid terminal and a flexible ligament system, to one another. The fastening techniques used for joints described in the Background, involving screwing or sewing, adhesive bonding or clamping by external elements, not only require time-consuming assembly, but may also lead to material damage and the formation of mechanical weak points. Furthermore, they are not capable of providing materially self-locking tool-free fixation, thereby significantly limiting industrial applicability and manufacturability.

To address these limitations, the present disclosure provides a ligament system comprising a pretensioned braided sheath configured to couple the terminals to one another. The braided structure of the sheath may enclose (fully or partially) the terminals or circumferential surfaces of the terminals. The fiber geometry and pre-tension of the braided sheath allow it to be fixed to the terminal surface in a form-fitting and self-supporting manner. This configuration can obviate the need for supplemental fastening elements, such as screws, adhesives, or sutures, to mechanically retain the sheath on the terminal, although such elements may be included in certain embodiments to provide auxiliary securement.

Thus, embodiments may include a ligament system that comprises a braided sheath configured to establish a mechanical engagement with at least one terminal of a joint, where the mechanical engagement retains the sheath in a stable position relative to the terminal while allowing the sheath to elongate and contract as the joint articulates. In some embodiments, the mechanical engagement comprises a positive locking engagement. In particular, the braided sheath may establish a positive locking engagement through form-fitting to the terminal. Through longitudinal-to-radial strain transformation, longitudinal strain in the braided structure urges the braided structure to radially contract about a terminal. Due to the flexibility/conformability of the braid structure, the braid structure can conform to the surface geometry of the terminal, which can be adapted such that, as the braided structure clamps about the terminal, this geometric conformation results in a complementary interface that provides mechanical interference against relative movement in one or more directions. In particular embodiments, the positive locking mechanism longitudinally anchors the braided structure to the terminal.

In some embodiments, the positive-locking mechanism (e.g., the braided structure seated in recesses or otherwise against geometry to create a positive locking interface) establishes an anchoring effect (anchor) that resists relative motion in one or more degrees of freedom. In some embodiments, the anchoring effect prevents relative longitudinal displacement between the end (or other conforming portion) of the sheath and the terminal. This anchoring effect is localized such that it does not impede the intrinsic longitudinal elongation of the braided structure during intended operation/range of motion of the joint. Rather, the axial anchor established by the form-fitting engagement can serve as a fixed datum from which the sheath may undergo tensile deformation, thereby increasing the previously described radial contact pressure against the articulating interfaces. In addition, or in the alternative, the mechanical engagement caused by the self-clamping behavior may result in friction locking engagement. Where the sheath circumferentially encompasses a rigid terminal, an applied longitudinal pretension is kinematically converted into a radial contact pressure. Because the rigid geometry of the terminal acts as a mechanical constraint preventing further radial contraction of the braid, the energy of the longitudinal strain is expressed as a normal force against the terminal. This results in a frictional engagement that unitizes the sheath and the terminal.

In some embodiments, the mechanical engagement resulting from the self-clamping behavior of the braided structure is sufficient to maintain the sheath in a stable position relative to the terminal without additional fastening elements, adhesives, or the like. Thus, the mechanical engagement caused by the self-clamping behavior of the braided structure can enable it to be fixed, in some embodiments, to at least one of the terminals in a self-securing manner.

Unlike weaving or loop-based processes (e.g., knitting or crocheting), a fiber arrangement formed during braiding is characterized by enhanced strength and load bearing, and exhibits a characteristic contraction and compaction that is at least locally homogeneous with respect to fiber alignment. Consequently, a braided ligament system is capable of exerting a directed clamping effect that conforms to the shape of the terminal surface geometry and establishes stable fixation thereon by mechanical engagement. Structural integrity and load-bearing capacity are enhanced because forces applied to individual ligament network elements (ligaments) as a result of inter-fiber friction and the braid conformability (e.g., elastic elongation) are redistributed over a proportionately large surface area of the enclosed terminal. This provides much more effective holding than point-like connections and also substantially reduces gradual degradation caused by uneven loading, because frictional forces at crossings reduce the load borne by individual fibers.

A further advantage is that in some embodiments, the fibers become tensioned under load applied to the joint, which increases the compressive force exerted upon the terminals. This self-tightening behavior in which longitudinal strain is converted into a radial compressive force ensures that the fixation becomes increasingly robust under active loading conditions. Additionally, the optimized fiber orientation and conformational capability allow the structure to respond to impulse loads through controlled elongation rather than rupture, thereby maximizing the total load-bearing capacity.

A braided ligament system is suitable not only for fixation but also for controlling the full joint range of motion and dynamically changing stiffness through geometric and material parameters, by way of example, braiding density, braid angle, fiber type, fiber modulus, filament count, textile pattern, ligament length, or pre-tension. For example, by adjusting parameters, the system may be tailored to define a specific range of motion and a non-linear stiffness profile for the joint. Similar to natural ligament systems, a braided sheath can constrict during bending and thereby increase stiffness as the joint approaches an end-of-range condition, providing passive motion limitation and progressive resistance. Such adaptive stiffness change is especially important for realistic mapping of biological joints and is not achieved by prior-art solutions in a unified, material-geometry-based manner.

Thus, the braided structure of the ligament system may be configured to provide progressive resistance to joint displacement. As the joint approaches the terminal limits of its range of motion, the geometry of the articulating interfaces induces an increase in longitudinal strain within the braided structure. This may, in some embodiments, trigger a non-linear increase in tensile force, effectively providing an elastic stop (or ‘soft stop’) that prevents undesired motion, such as but not limited to hyper-extension or hyper-flexion. This passive ligamentous constraint ensures that the coaptive force and lateral stability are highest at the points of maximum mechanical stress, thereby protecting the integrity of the articulating interfaces.

The braided ligament system may be configured for regional modulation of mechanical and structural properties. One or more geometric or material parameters, including but not limited to braiding density, braid angle, fiber material, fiber modulus, filament count, textile pattern, ligament length or pre-tension, may be selectively varied across different regions of the ligament system. For example, a ligament system may include one or more first regions having relatively increased fiber density or tighter braid architecture to provide increased retention at predetermined terminal-interface locations, and one or more second regions having a different braid architecture, reduced fiber density, or reduced pre-tension to provide localized compliance and motion accommodation at terminal junctions or bending zones.

Further, by selectively varying the braiding patterns and macro-structural definitions, branches satisfying design intent can be formed (e.g., ligaments modeled on anatomical systems) resulting in functionally different ligament portions. Such controlled structural differentiation can include ligament portions having intentionally different functional responses, enabling localized control of joint functions. The braided ligament system may thus emulate region-dependent behavior of biological fiber bundles, in which mechanical response varies as a function of location and fiber-bundle participation. In contrast to conventional ligament systems that exhibit substantially uniform mechanical profiles, embodiments of the present disclosure support non-uniform mechanical differentiation across the ligament system. This allows the ligament system to exert varied radial pressures and accommodate complex loading profiles that are not achievable in systems lacking such regional structural variation.

In certain embodiments, a braided ligament system is manufacturable in a single manufacturing operation by braiding fibers directly onto, around, or over the terminals in a single manufacturing operation. Forming the braided ligament system in situ relative to the terminals can eliminate, or at least reduce, post formation assembly steps otherwise required to attach a separately manufactured ligament-structure to the terminals. In addition, such in situ braiding enables manufacture, placement, and fixation of the ligament system and the terminals to be performed simultaneously, including in a fully or partially automated process (e.g., robotic or CNC-controlled braiding and fixturing). This represents a significant manufacturing advantage and provides a technical improvement over joint mechanisms requiring separate ligament fabrication and subsequent manual assembly, as it reduces the likelihood of dimensional inaccuracies, assembly errors or limitations, or mechanical wear associated with multi-component integration, ensuring greater structural and operational reliability.

The braided ligament system may incorporate auxiliary functional elements which further increase functional adaptability, motion guidance, fixation, and active operation. Examples of auxiliary functional elements include, but are not limited to, elastic, rigid, or flexible fibers and/or inserts; cores (e.g., for strengthening tensile strength, adding conductive function to a braid, or other functionality); beads (e.g. mechanical fillers to make protruding, larger diameter sections for a braid); loops or guides for routing tendons; point-attachment loops, or protrusions formed by overmolding, adhesion, insertion, or over-braiding. In certain embodiments, guidance elements integrated into the braid do not form separately manufactured parts, but are braided directly into the textile structure, avoiding weak points and additional fixation. Similarly, tendons or networks of tendons may be integrated into the braid. The structural continuity of the braided ligament system may enable integration of tendons, actuating elements, or sensors as part of one unified structure.

Embodiments of the present disclosure include joint mechanisms that employ a braided ligament system. The joints of a joint mechanism employing a braided ligament system may be configured to permit articulation within defined kinematic envelopes, where the defined kinematic envelope for a joint comprises one or more primary degrees of freedom. Embodiments may combine linear and non-linear displacements. In certain embodiments, these primary degrees of freedom include one or more degrees of freedom selected from i) translational degree of freedoms, such as axial translation (e.g., longitudinal sliding or translation of a terminal along its longitudinal axis, lateral gliding or translation (e.g., anterior-posterior or lateral-medial), or other linear displacements of a terminal relative to the joint center; or ii) rotational degrees of freedom including, but not limited to, angular articulation in one or more planes, such as flexion and extension, abduction and adduction, rolling, or rotation of a terminal about its longitudinal axis. In certain embodiments, the joint mechanism or a joint thereof may combine one or more of the aforementioned degrees of freedom. Such compound motions may emulate biological joint responses or fulfill specific kinematic requirements. Within this architecture, the ligament system is configured to facilitate, modulate or constrain said motions according to a predetermined design intent.

In some embodiments, at least one joint of the joint mechanism functions as a uniaxial joint having one principal degree of freedom, such as a pivot type joint permitting rotation about a single axis or a hinge type joint permitting flexion and extension-substantially within a single plane. In addition or in the alternative,-one or more joints of the joint mechanism functions as a biaxial joint having two principal degrees of freedom, such as a modified hinge joint permitting flexion and extension together with limited lateral medial motion, a condyloid joint, or a saddle joint. Further in some embodiments, one or more-embodiments of the joint mechanism functions as a multiaxial joint having three or more principal degrees of freedom, such as a ball-and-socket joint permitting rotational motion about multiple axes and, in some embodiments, limited translational motion. In addition to the principal degrees of freedom, a joint may exhibit constrained arthrokinematic or accessory motion (e.g., rolling, sliding, or other rotational or translational displacements) occurring at the articular interfaces in conjunction with the primary motion. Such secondary motion may combine linear and non-linear displacements and may be mechanically constrained by the geometry of the articulating members or constrained (e.g., elastically) by the ligament system so as to remain within predetermined limits while enabling functional articulation.

One or more joints of the joint mechanism may employ a biomimetic architecture that mimics biological behavior, where a biomimetic joint comprises a plurality of interconnected structural links configured to approximate the physiological kinematics and degrees of freedom of a biological human joint and includes an artificial ligament system that mimics the kinematic constraints of biological ligaments to manage joint stability, limit undesirable ranges of motion and facilitate force distribution across terminal surfaces. In certain embodiments, the joint mechanism comprises one or more of the following: a biomimetic uniaxial joint, a biomimetic biaxial joint, or a biomimetic multiaxial joint having three or more degrees of freedom.

The braided ligament system may be fixed to one or more terminals in a self-supporting manner through self-clamping that results in mechanical engagement with the one or more terminals. In certain embodiments, the ligament system is configured to exhibit functionally differentiated mechanical behavior across regions of the braid. Such functionally differentiated mechanical behavior may be provided in a ligament system that fully covers a joint (e.g. a ligament system that does not have differentiated gaps between braided ligaments) or a ligament system that is split in multiple branches that have openings in between. By virtue of the structural continuity of the braided architecture, the joint mechanism may be implemented with reduced assembly complexity, improved structural integrity at fixation interfaces, and controllable stiffness characteristics that vary with joint articulation. In this manner, embodiments can provide a biologically inspired joint behavior while remaining compatible with industrially scalable and repeatable manufacturing processes, thereby supporting long-term operational stability and reliability.

The structural continuity and conformational capability of joint mechanisms according to the teachings of the present disclosure can enable embodiments to accommodate complex loading profiles while mimicking the kinematic behavior of biological joints. Consequently, joint mechanisms according to the present disclosure are particularly suited for robotics, biomechanical systems, and orthotic applications where a combination of high-compliance interfaces, integrated structural design, and high weight-to-strength ratios is required. Embodiments may further facilitate the realization of multi-joint kinematic chains within a single, continuous braided structure.

In certain embodiments, the joint mechanisms described herein form part of an articulating structure. The articulating structure may be an actuated structure such as a robotic structure, powered exoskeleton or other structure in which articulation of the joint structure is driven by one or more motors, solenoids, linear actuators or other actuators. In other embodiments, the articulating structure is a non-motorized structure, such as, but not limited to body-powered prosthetics. In some embodiments, one or more joints of a joint mechanism are actuated while one or more or joints are non-actuated.

The articulating structure may comprise one or more joint mechanisms, each joint mechanism including a plurality of terminals mechanically coupled by a braided textile ligament system as described above. The articulating structure may be a robotic articulating structure configured as a robotic limb, robotic finger, robotic hand, robotic arm, robotic leg, end effector, manipulator, humanoid appendage, or other mechanical system requiring controlled relative movement between rigid elements.

In some embodiments, the articulating structure (actuated or unactuated) structure comprises a kinematic chain including a plurality of joints arranged in series, parallel, or branched configurations. Adjacent joint mechanisms may share one or more terminals, or a terminal of a first joint mechanism may serve as a base body or reference structure for a second joint mechanism. The braided ligament system may extend continuously across multiple joints, thereby forming a continuous load bearing textile structure spanning two or more articulated joints.

In some embodiments, the-articulating structure includes rigid base bodies or mounting elements coupled to one or more terminals of the joint mechanism. Such base bodies may be configured to support actuators, sensors, or external loads, and may cooperate with the braided ligament system to reinforce fixation, guide load paths, or constrain degrees of freedom.

The articulating structure may be configured to permit one or more degrees of freedom at each joint, including but not limited to translational degrees of freedom, rotational degrees of freedom or combinations thereof. Thus, by way of example and not limitation, a joint may exhibit constrained sliding, rolling, bending, extension, rotation, orbiting, torsion, translation, or combinations thereof. The geometry of the terminals, the routing and branching of the braided ligament and tendon systems, and the regional properties of the braid may be selected to define kinematic envelopes, motion limits, and stiffness profiles for individual joints or coordinated groups of joints.

Turning to the figures, the figures depict various embodiments of joint mechanisms and ligament systems. For simplicity, the individual braided fibers are not shown in each figure. It is contemplated that, unless otherwise stated as mutually exclusive, the various features, structures, and functional characteristics described in relation to any one embodiment herein, including features, structures and functional characteristics described above, may be combined with, or substituted for, the features, structures, and functional characteristics of any other embodiment to create further embodiments, including intermediate embodiments, without departing from the scope of the disclosure. The presentation of a feature in a specific drawing is intended to be exemplary and not limiting; the invention may be practiced with any combination of the described elements provided the combination remains functionally viable.

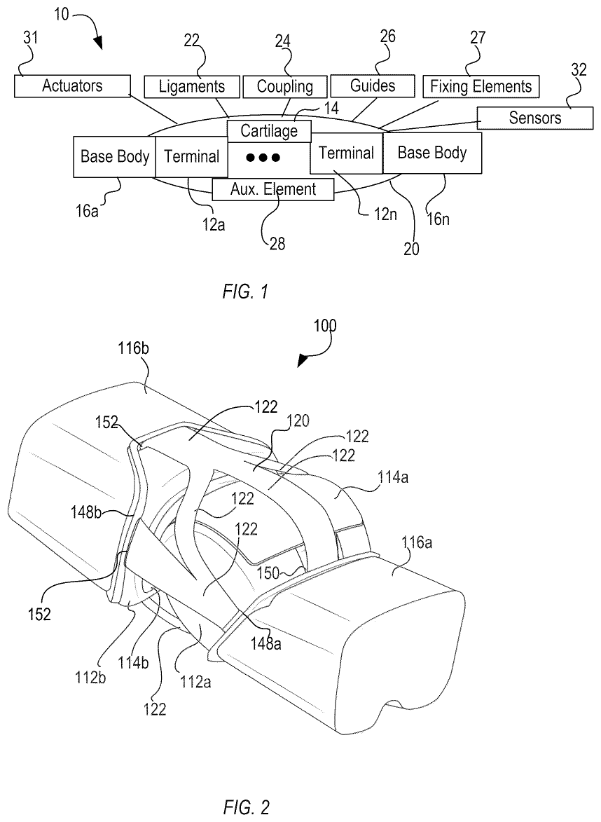

FIG. 1 is a block diagrammatic representation of one embodiment of a joint mechanism 10 comprising two or more terminals (terminal 12a . . . terminal 12n) (generally referred to as terminals 12) coupled by a ligament system 20. The ligament system and terminals may form one or more joints, with each joint comprising two or more of the terminals 12. The joints of the joint mechanism 10 may be configured to permit articulation within defined kinematic envelopes, where the defined kinematic envelope for a joint comprises one or more primary degrees of freedom, non-limiting examples of which are discussed above. Further, joints of the joint mechanism may exhibit constrained arthrokinematic or accessory motion. The joints of the joint mechanism 10 include, in some embodiments, at least one of the following: a uniaxial joint, a biaxial joint, or a multiaxial joint with three or more degrees of freedom. One or more of the joints of the joint mechanism may employ a biomimetic architecture. In certain embodiments, joint mechanism 10 forms part of an articulating structure, such as an actuated or non-actuated structure as discussed above. Similarly other joint mechanisms described herein may form part of an actuated or non-actuated structure.

The terminals 12 are structurally and functionally defining articulated components adapted to move relative to one another. Terminals may be made of various materials suitable for a joint including, but not limited to, a rigid plastic (e.g., produced by 3D printing, injection molding, or other mechanism) or a metal alloy, but are preferably of a composite structure ensuring sufficient structural strength, low friction, and a surface geometry adapted to anatomical behavior. The design of the terminals 12, and the nature of their mechanical articulation, may take various forms (for example, the articular surface may be of spherical-cap shape if the joint imitates, for example, a metacarpophalangeal joint).

In certain embodiments, the terminals 12 define, or are integrally formed with, the rigid structural members (e.g., “links” or “bones”) of a robotic or mechanical skeletal architecture. These structural members may be modeled on physiological skeletal structures to provide a biomimetic mechanical response. The terminals 12 may comprise articular surfaces configured to facilitate relative articulation between the terminals, wherein the geometry of said surfaces may define a permitted range of motion as constrained by the ligament system 20.

In some embodiments, a first terminal of a joint comprises a convex articular projection (e.g., a bone head, condyle, or other arcuate projection) and a second terminal comprises a complementary receiving surface (e.g., a concave socket, fossa, or other receiving surface) configured to receive said a convex articular projection. In other example embodiments, a first terminal and a second terminal both have convex articulator surfaces, and the terminals roll on each other while being kept together by the ligament system 20. The terminals may also have other configurations that, for example, imitate articulator interfaces of human bones. Further, in some embodiments, the terminals may be joined by a mechanical joint that provides desired degrees of freedom using conventional linkage connections (such as a pin and bearing connection or other conventional linkage connection) while being covered and constrained by the braided ligament system 20.

The joint may be configured to exhibit constrained arthrokinematic motion between the articular surfaces—such as sliding, gliding, or rolling—to maintain congruent interface contact throughout the kinematic envelope and avoid point-loading or decoupling of the terminals. In certain embodiments, a joint may integrate a cartilage layer 14 on one or more of the articular surfaces of the terminals improving friction properties between terminals 12 or wear resistance. By way of example and not limitation, the cartilage layer 14 may comprise a PTFE component or another low-friction polymer coating.

The ligament system 20 may be formed as a braided-structure sheath, which may be formed of mutually interwoven braided fibers. non-limiting examples of which are provided above (e.g., polymeric materials, thermoplastic or elastomeric materials, metallic materials, mineral-based fibers, carbon fibers, glass fibers, natural fibers, or fibers formed from other materials or combinations thereof provided in monofilament or multifilament form). In certain embodiments, the ligament system 20 forms a shell-like capsule, such as a cylindrical or spherical-shell-like capsule, around the terminals 12. According to its geometric configuration, the ligament system 20 may be regularly braided, asymmetrically meshed, or have a branching geometry. The arrangement may, for example, be implemented such that, in certain zones of the sheath, overlapping or branching ligament portions 22 are formed. The braided-structure sheath may be a braided sleeve that circumferentially surrounds the surface of at least one terminal in a sheath-like manner to mechanically engage the at least one terminal in, for example, a form-fitting or friction fitting manner.

The ligament system 20 may hold together the terminals 12 of a joint. In certain embodiments, the ligament system 20 mechanically engages with terminals through self-clamping or may be otherwise fixed to the terminals. In certain embodiments, the axial tension in the braided structure sheath increases as the terminals distract resulting in a reciprocal axial compressive load (a coaptive force) applied to the terminals, thereby approximating the articular surfaces. In some embodiments, the braided structure of the ligament system 20 includes a pre-tension (preload) and therefore asserts a coaptive force to approximate the articular surfaces even when the joint mechanism 10 is unloaded by external forces. The coaptive force can stabilize the joint by compressing the terminals together, enhancing stability, and preventing abnormal translation or dislocation. The captive force can ensure that the terminals remain in a state of congruent engagement, resisting joint distraction and maintaining stability during high-velocity or high-load articulation.

In addition to establishing the mechanical connection, the ligament system 20 also provides freedom of movement between the terminals 12, while at the same time restricting their displacement in predetermined directions, thereby simultaneously fulfilling connecting, actuating and stopping functions. By virtue of its braided configuration, the ligament system 20 is integrated with the terminals into a structurally and functionally unified whole, which may in some embodiments be formed in a single step, for example by three-dimensional over-braiding. Further, in some embodiments, a continuous braided textile structure can provide the ligament system for multiple joints.

Ligament system 20 asserts a directed clamping effect that conforms to the shape of a terminal surface geometry and may establish stable fixation thereon by form-fitting (positive locking) or friction locking engagement. The geometric and material properties of ligament system 20 may be tailored to define a specific range of motion and stiffness profile for each joint of the joint mechanism 10. In various embodiments, the ligament system 20, through its braided structure, functions as a dynamic stabilization architecture configured to regulate joint kinematics according to the specific degrees of freedom of the articular interface. In multiaxial configurations, such as a ball-and-socket joint, the ligament structure may be configured to maintain the centration of the arcuate projection within the receiving articular surface, specifically managing stability during abduction and adduction and preventing subluxation. In uniaxial or biaxial configurations, such as hinge, modified hinge, condyloid, or saddle joints, the sheath may operate to restrict off-axis parasitic motions, including unwanted lateral displacement in one or more directions (e.g., medial-lateral shift, anterior-posterior shift), while simultaneously facilitating constrained arthrokinematic translation (e.g., rolling and sliding). The braided structure of the ligament system 20 can provide a resilient restorative force that optimizes load distribution and maintains surface congruence between the articulating members throughout the full operational range of motion.

In certain embodiments, the braided architecture is configured to undergo radial constriction during joint articulation (e.g., bending), which increases the circumferential compressive force distributed across the contact area of the terminal. This radial constriction may facilitate a progressive stiffening of the ligament system as the joint approaches the limits of its kinematic envelope, thereby providing an integrated passive motion constraint. This adaptive stiffness variation can enable a biomimetic response that emulates the physiological behavior of biological ligamentous structures. In certain embodiments, ligament system 20 is configured to provide for regional modulation of mechanical and structural properties.

In at least one bending state of the joint mechanism 10 (e.g., fully extended, fully bent, partially bent), the ligament system 20 attaches in a form-fit or friction locking manner to the surface of at least one terminal 12 due to the self-clamping effect of the braided structure. This self-clamping effect originates from the local compressive forces resulting from the behavior of the pretensioned fibers, and from the characteristics of braids and braiding processes themselves.

In some embodiments, fixation to the at least one terminal of a joint is not provided by separate mechanical parts or assembly steps, but solely by the engagement of the braided sheath with the at least one terminal. Due to fiber arrangement and axial fiber tension created during manufacturing, the braided sheath exerts circumferential radial pressure on the surface of the at least one terminal 12, thereby mechanically fixing itself to the surface through mechanical engagement (e.g., form-fitting, friction or a combination thereof). In the braided structure, fiber angles and tensions together define the internal pressure. If the pressure is sufficiently large, this alone can be enough to keep the ligament system 20 stably positioned by means of the mechanical engagement created by the self-clamping effect. However, some embodiments may use auxiliary fixation mechanisms.

The self-clamping effect of the braided ligament system 20 is present in at least one bending state of the joint mechanism 10, however, depending on the particular embodiment, this self-clamping fixation may be exerted in different ways and in different states. In certain configurations—particularly when the geometric configuration of the terminals or the manufacturing pre-tension of the ligament system 20 allow—positive-locking fixation may be present at rest, that is, when the joint mechanism is assembled but unloaded. In such cases, the braided-structure sheath, as a result of the pre-tension formed during manufacture—especially in the case of over-braiding—already carries a sufficient level of internal fiber tension in the initial position to clamp onto the terminals having the corresponding geometry, ensuring self-stabilizing fixation.

In some embodiments, fixation of the ligament system 20 is not fully clamped in all conditions, but instead only tightens sufficiently in certain operating states of the joint mechanism 10 such that the fixation acts in a self-fixing manner through form fitting, friction locking or a combination thereof. In such embodiments, one or more ligament portions 22 may be relatively loose with respect to the terminals 12 in a rest state. However, when joint mechanism 10 articulates or is subjected to external loading, the ligament system 20 is placed under load—for example by tensile loading, torsional loading, or other loading—the internal radial pressure of the braided structure increases. As a result of load-induced compaction and contraction, the fibers generate an increased circumferential constricting force around at least one terminal 12 that increases as a function of the applied load and is distributed over the contact regions between the braided sheath and the terminal surface of the at least one terminal 12. In such cases, the braid architecture actively contributes to maintaining fixation and promotes efficient distribution and transmission of structural loads over the contact surface, thereby reducing localized stress concentration at discrete attachment points.

The clamping effect may in certain cases be minimal when the joint is unloaded; however, this does not result in functional instability of the structure, provided that cohesion of the elements (e.g., terminals 12) in the given position is sufficient to prevent separation, which, for example in the case of an appropriately braided structure, is inherently ensured by the fibrous structure itself. The ligament system 20 thus dynamically adapts to the state of the joint mechanism throughout the entire operating cycle and ensures the desired structural stability in a manner characteristic of the given embodiment.

The reliability and long-term stability of the fixation of the ligament system 20 to a terminal 12 based exclusively on the clamping effect of the ligament system 12 can be further increased if at least one terminal 12 is additionally provided with a shaped surface region for fixation. The shaped surface region is a geometric modification formed on the surface of the terminal 12 that serves to improve positioning and fixation of the ligament system 20. The shaped surface region may be implemented, for example, as a tapered portion (e.g., conical, frustum or other tapered portion) or stepped surface, or as a surface comprising grooves, serrations or recesses configured to receive a portion of the ligament system 20, such as ligaments, fibers, or the braided sheath. According to an exemplary embodiment, the shaped surface region is implemented in the form of one or more grooves extending along the entire circumference of the terminal, into which the ligament system 20 is self-supportingly pressed as a result of its material structure, whereby the ligament system 20 is fixed to the terminal 12 in a positive-locking manner. In this example, the braided ligament system 20 not only bears against the outer surface of the terminal 12 but also seats into a portion of the terminal 20, thereby increasing the positive-locking character and reinforcing the connection in terms of shape in addition to the clamping effect exerted.

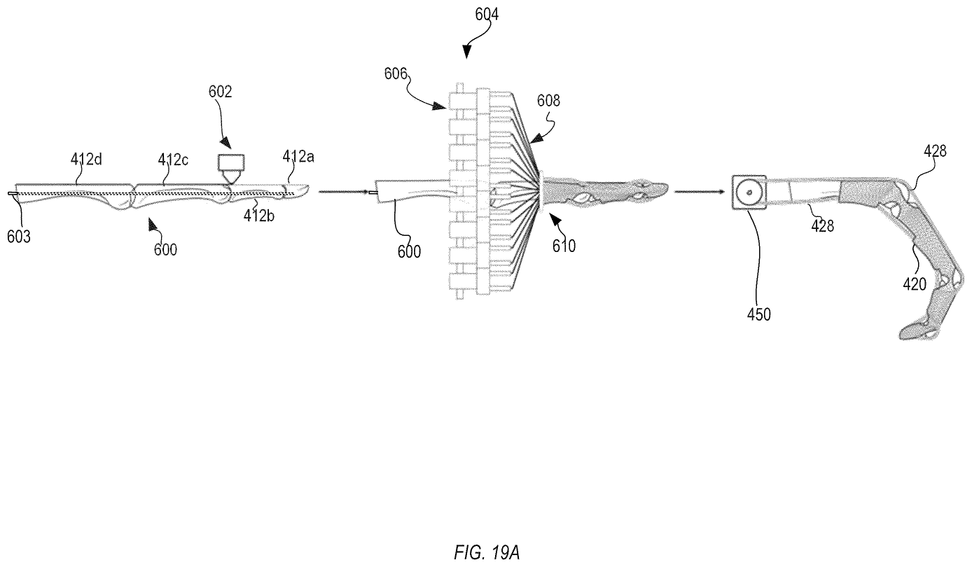

In some embodiments, additional functional elements can be integrated into the braided ligament system 20—such as elastic, rigid or flexible fibers and/or inserts, as well as loops or guiding parts for routing coupling elements, or optionally loops or other fixation parts formed on the ligament system enabling point-like fixation (non-limiting examples of which are illustrated in FIGS. 18A-18C), or protrusions formed by various methods (for example by molding, adhesive bonding or insertion)—which further enhance the functional adaptability, motion guidance and active operation of the joint mechanism. Examples of additional functional elements that may be included in the ligament system 20 include, but are not limited to, coupling elements 24, guiding parts 26, and fixing elements 27. According to certain embodiments, one or more coupling elements 24 (e.g., tendons or other coupling elements), guiding parts 26, or fixing elements 27 do not constitute separate components requiring independent manufacture and fitting but can be braided or otherwise formed directly into the textile structure of the ligament system 20 itself, thereby not representing weak points and not requiring additional fixation. Further, the braided ligament system 20 may integrate actuating elements or sensors.

One or more coupling elements 24 may serve to actuate the joint mechanism, for example as a traction mechanism that transmits motion energy while imitating the operation of natural tendons. In other words, one or more coupling elements may serve as tendons. A coupling element 24 that acts as a tendon may be a wire, braided fiber bundle or a branching network of braided fiber bundles, or flat strap element, or other coupling element and can connect at one end to a defined point of the ligament system (e.g., by an end knot or other mechanism) and at the other end to an external actuator (not shown), e.g., an electric motor, pneumatic cylinder, or Bowden-cable system.

In some cases, one or more coupling elements 24 do not transmit energy for movement purposes but serve to fix the entire joint mechanism to an external structure, for example to a part of a robotic arm or a biomechanical frame structure, or to another joint mechanism. In such cases, the coupling element may be an elastic fiber, strip, wire, branching structure, or other element that ensures positioning of the ligament system 10 and stabilization against external forces.

The guiding part 26 for a coupling element 24 may allow rapid threading and unthreading of the coupling element 24 if the system configuration or application purpose requires interchangeable or adjustable mechanical connections. Such a modular configuration may be particularly preferred in medical devices, human-machine interfaces, and in robotic applications where fine tuning of motion control is implemented at the level of the mechanical structure.

In some embodiments, at least one insert is integrated into the ligament system 20. The insert may be rigid, flexible or elastic, depending on the mechanical or functional role to be fulfilled, and may influence the mechanical or functional properties of the ligament system 20 or portion of joint mechanism 10. The insert may, for example, serve to limit axial rotation, lateral movement (e.g., one or more of medial-lateral or anterior-posterior) of the joint, longitudinal displacement of the terminals, or act as a local stiffening element to stiffen the joint relative one or more motions including, but not limited to bending, or serve to carry electronics, a sensor, or an actuating element. The inserts may further be, for example, elastic fibers providing direction-dependent elastic properties to a given portion of the ligament system 20, conductive fibers for wiring or sensor integration, or even stiffer metal fibers for providing tone or local stiffness or semi-rigidity. In certain cases, the braiding process may allow the insert fibers to be locally integrated into the braided ligament system 20 as fibers participating in the braiding itself. Such inserts are threaded directly into the ligament system 20 during the braiding process, thereby not interrupting its structural continuity.

In some embodiments, actuators 31 may be incorporated into the braided structure. For example, the braided structure of the ligament system 20 may include artificial muscle-like structures using contracting substructures, such as liquid crystal elastomer or dielectric fibers or pneumatic/hydraulic artificial muscles, such as, but not limited to McKibben muscles. In other embodiments, coupling elements may connect the ligament system 20 to external actuators or the joint mechanism 10 may be unactuated. Further, in some embodiments, the ligament system 20 may include integrated sensors 32, such as, but not limited to, one or more tactile, strain, or stress sensors via, for example, certain configurations of conductive fibers.

In some embodiments, a form-fit connection may be reinforced by one or more fixing elements 27. A fixing element 27 provides mechanical support to the form-fit fixation of the braided sheath. In one embodiment, the fixing element 27 may be a protrusion or other feature that positively engages a given portion of the ligament system 20 at a defined point of the terminal 12. A fixing element 27 may comprise, for example, a thickened portion, such as a protrusion that grips a portion of the ligament system at a specific terminal point or a thickened portion incorporated between, or formed from, the braided ligament portions, such as an end knot, a braided lug, a rigid insert, an overmolded element, or other element which engages into a fixing cavity formed in the terminal 12. The fixing cavity may be, for example, a cylindrical, tapered (e.g., conical, frustum or other tapered shape) or buttonhole-like depression providing a tight-fitting engagement required for the positive-locking connection. A fixing element 27 may be of an end-terminating type, which at the same time finishes the fibers of an associated ligament portion 22, thereby forming an end point on the ligament system 20, or may be of a continuous type, which does not interrupt the ligament structure but, after providing fixation, allows the contained ligament portion 22 to pass through.

The structural hold of the ligament system's braided structure may, by itself or with additional fixing elements 27, be sufficient to fix the ligament system 20 and thus hold the joint together and bear actuation and external loads. Nevertheless, further auxiliary elements 28 may be applied to strengthen fixation or for fiber end finishing. For example, embodiments may include one or more auxiliary elements 28 coupling the ligament system 20 to at least one terminal 12 to further reinforce the positive-locking connection. An auxiliary element 28 may be configured to supplement the positive-locking fixation of the braided-structure sheath with mechanical support.

In some embodiments, a fastener, such as a screw, bolt or other fastening element may be used as an auxiliary element 28 to provide auxiliary fixation. As another example, an auxiliary element 28 may comprise a clamp (e.g., a clamping ring, such as a sleeve or other clamping ring), which may be made, for example, of spring steel, wire, rigid plastic, a textile-based elastic braid or other material. In one embodiment, a clamping ring or sleeve is fitted onto the outer circumference of a shaped surface region of a terminal 12 and, by clamping the ligament system 20 from the outside, provides additional fixation thereof, pressing the ligament system 20 onto the terminal 12 in a ring-like manner, thereby increasing stability, particularly under high load conditions. This may be particularly preferred in cases where the structure is subjected to periodically occurring dynamic loads, and where, in addition to the positive-locking fixation provided by the braiding, a further redundant fastening solution is required or preferred.

In some embodiments, the joint mechanism 10 comprises a layered sheath. For example, ligament system 20 comprises a plurality of braided sheaths arranged in layers one above another. The sheaths may preferably have different fiber orientations, braiding patterns, branching structures or material compositions on a layer-by-layer basis, allowing the mechanical and functional characteristics of the joint mechanism to be optimized on multiple levels. For example, certain sheath layers may serve to guide bending movement, while other layers provide reinforcement against axial shear or torsion. An advantage of the layered configuration is that, for example, inner sheaths may be more flexible and more closely follow the movement of the terminals 12, while outer layers may provide structural stability, wear protection or other functional roles, such as sensor support or electrical shielding.

In certain cases, the braided-structure sheaths are not arranged merely as concentric, successive layers, but may be arranged in other ways. In some embodiments, the braided-structure sheaths or other layer structures are at least partially braided into one another, for example via common nodes, by changing the braiding pattern, or by overlapping loop formations. As a result, the structure does not merely form a layered arrangement, but rather a coherently integrated unit that is capable of providing complex mechanical responses to applied loads.

Although, by definition, the presence of two or more terminals 12 and the ligament system 20 connecting them is sufficient to define a joint, the joint structure may also comprise a connection formed on any surface of one or more terminals 12 other than the articular surfaces thereof. By its function, such a connection fixes the joint to further structural elements of the system, for example to the frame of a mechanical or robotic system containing the joint, or to objects to be actuated. One or more terminals 12 may be coupled to a base body (e.g., base body 16a . . . 16n) (generally referred to as base bodies 16). By way of example and not limitation, a single terminal 12 may be connected to a plurality of separate base bodies 16, or a single base body 16 may be connected to a plurality of separate terminals 12. A terminal 12 or a base body 16 may itself comprise a plurality of separate components fixed to one another in any manner, and a terminal 12, as a component or functional unit, may in one role serve as the base body 16 of another terminal 12, either in the same joint or in a different joint.

A base body 16 may, for example, be the object to be actuated itself or a frame element of a mechanical or robotic system containing the joint. The surface of the base body 16 contacting or facing a terminal 12 may, together with the corresponding surface of the terminal 12 and by being clamped thereto, reinforce or ensure fixation of the ligament system 20 at shaped surface regions or at point-like fixing connection.

A base body 16 may be fixed to a terminal 12, for example, by one or more fastening elements, adhesive bonding, or using other techniques in such a manner that mutually matching surface configurations of the terminal 12 and the base body 16, or the number, positions and tensile forces exerted by the fastening elements prevent at least one of rotation or displacement of the components relative to one another with respect to unintended degrees of freedom. In addition to fixing terminal and base body, a fastener may serve other functions in the structure containing the joint, for example, fixing an external, independently manufactured tendon (or tendon system) by looping or knotting around it, or secondary securing of the ligament system by additional over-braiding or by hooking onto buttonholes/loops formed in the braided structure—whereby a region of the fastener may remain accessible through openings even after fastening.

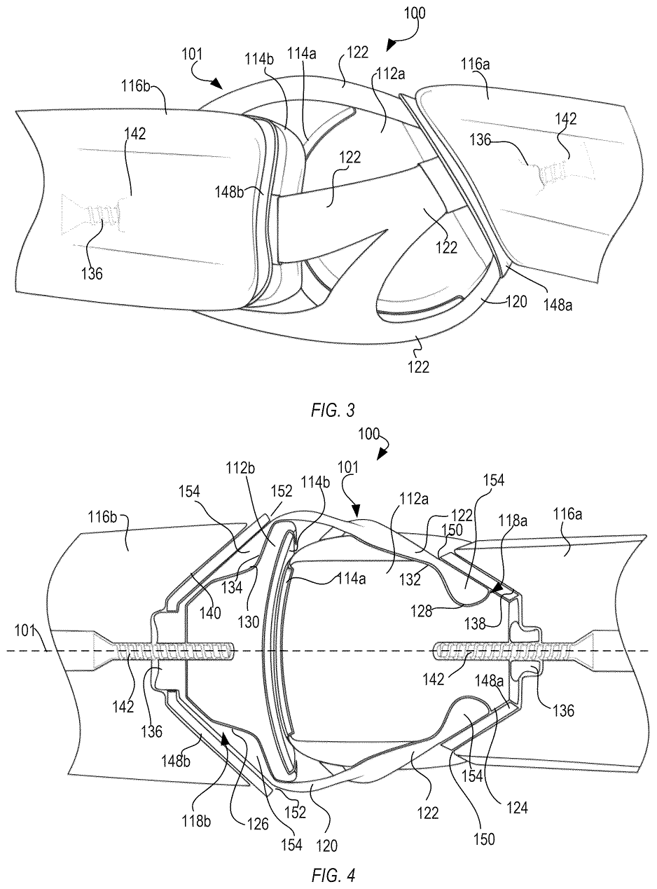

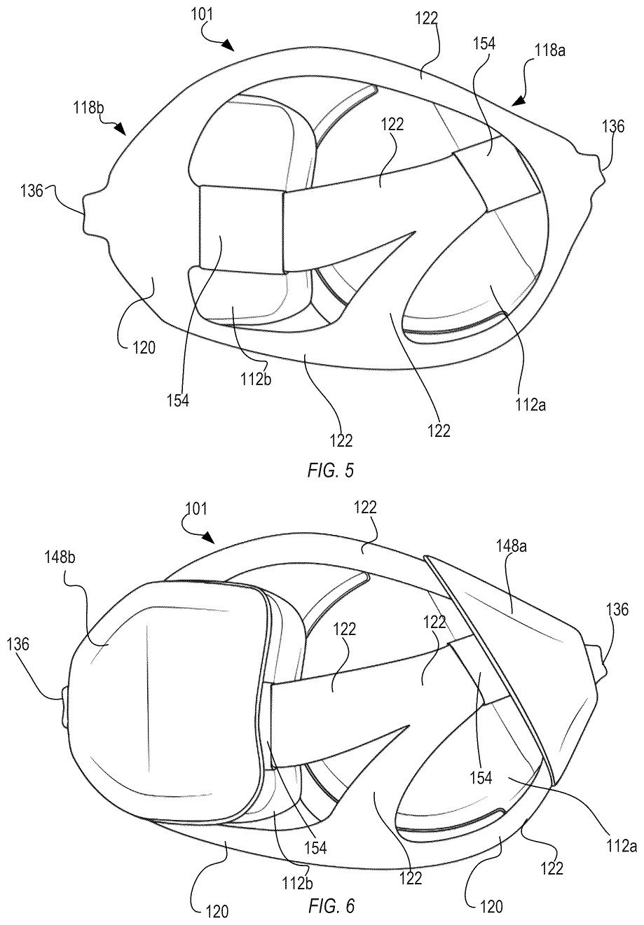

As discussed, a joint mechanism may comprise a plurality of terminals. Referring to the embodiment illustrated in FIGS. 2-9, for example, a joint mechanism 100 includes an articulated joint 101 comprising a first terminal 112a and a second terminal 112b connected by a ligament system 120 (first terminal 112a and second terminal 112b are referred to generally as terminals 112). The terminals 112 are structurally and functionally defining articulated components adapted to move relative to one another and may be made of various materials depending on implementation, non-limiting examples of which are described above. In certain embodiments, the joint mechanism 100 may integrate one or more cartilage layers (cartilage layer 114a and cartilage layer 114b) improving friction properties or wear resistance. Non-limiting examples of cartilage layers are discussed above. Other embodiments may omit one or more of cartilage layer 114a or cartilage layer 114b.

The terminals 112 are connected by the ligament system 120, which is formed as a braided-structure sheath that, in some embodiments, forms a cylindrical or spherical-shell-like capsule around the terminals 112. The ligament system 120 comprises interlaced braided fibers, which may be made of various materials and structural forms, non-limiting examples of which are discussed above. Depending on geometric routing, the ligament system 120 may be regularly braided, asymmetrically meshed, or branching, such that in some zones ligament portions 122 overlap or branch from each other.

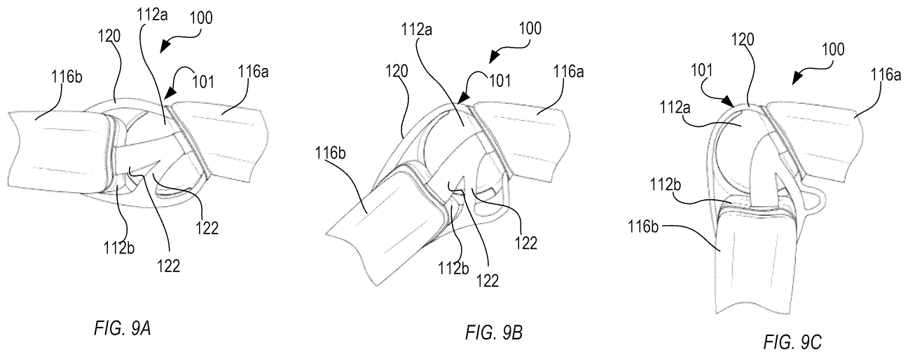

As illustrated in FIG. 4, the longitudinal axes of the terminals 112 and the ligament system 120 are generally parallel to centerline 103. However, as illustrated, for example in FIGS. 9A-9C, the longitudinal axis of ligament system 120 is dynamic. In some embodiments, at the fixation interface with a terminal 112, the ligament system 120 is geometrically anchored to the terminal to maintain a fixed angular relationship angular (e.g., collinear or at a predetermined offset) with the longitudinal axis of said terminal. It will be appreciated that the longitudinal axes of the terminals and ligament system being generally parallel in at least one state of the joint is merely one embodiment and, in other embodiments, including but not limited to joints with three or more terminals or a forking kinematic chains, the longitudinal axes of the terminals may not be parallel with each other or with the longitudinal axes of the ligament system.

In addition to establishing the mechanical connection, the ligament system 120 also provides freedom of movement between the terminals 112, while at the same time restricting their displacement in predetermined directions, thereby simultaneously fulfilling connecting, actuating and stopping functions. In certain embodiments, the geometry of the terminal articulator surfaces and ligament system 120 allow for one or more primary degrees of freedom. Further the joint may exhibit constrained arthrokinematic or accessory motion occurring at the articular interfaces in conjunction with the primary motion with such secondary motion being elastically constrained by the ligament system 120 in cooperation with the geometry of the terminals 112. By virtue of its braided configuration, the ligament system 120 is integrated with the terminals 112 into a structurally and functionally unified whole, which may be formed, in some embodiments, in a single operation, for example by three-dimensional over-braiding.

Ligament system 120 asserts a directed clamping effect that conforms to the shape of the terminal surface geometry and may establish stable fixation thereon by positive-locking engagement. As discussed above, the clamping effect is based on the fact that, in the braided structure, the angle and tension of each fiber jointly determine the resulting internal pressure, which, when sufficiently high, may in itself be sufficient to retain the ligament system 120 in a stable position. The geometric and material properties of ligament system 120 may be tailored to define a specific range of motion and stiffness profile for the joint. In certain embodiments, the braided architecture is configured to undergo radial constriction during joint articulation (e.g., bending), which increases the circumferential compressive force distributed across the contact area of the terminal and can facilitate a progressive stiffening of the ligament system to provide an integrated passive motion constraint. In certain embodiments, ligament system 120 is configured to provide for regional modulation of mechanical and structural properties.

In certain embodiments, the ligament system 120, in at least one geometric state (e.g., bending state) of the joint mechanism 100, attaches in a positive-locking manner to the surface of at least one terminal 112 due to the clamping effect of the braided structure. In some embodiments, fixation is not provided by separate mechanical parts or assembly steps, but solely by the engagement of the braided sheath with the at least one terminal 112. However, other embodiments may use auxiliary fixing mechanisms. Depending on the particular embodiment, this positive-locking fixing function may be exerted in different ways and in different states. In some embodiments, the braided-structure sheath may have sufficient pretension in the initial position or rest position to clamp onto the terminals 112 having the corresponding geometry.

In some embodiments, the ligament system 120 may only tighten sufficiently in certain operating states to achieve positive lock fixation. In such cases, strap portions may be looser relative to the terminal 112 in the rest state, but when the mechanism moves or is loaded externally and the ligament system is placed under load (e.g., pulled, rotated, or axially tensioned), internal pressure increases and fibers apply distributed pressure over the contact area of the terminal 112, increasing in proportion to load. In this way, the braid actively contributes to maintaining fixation, ensuring that structural loads are transmitted effectively and distributed across the contact surface. The clamping effect may in certain cases be minimal when the joint is unloaded, though the structure of ligament system 120 may have sufficient tension to maintain form-fit (positive lock) engagement or otherwise prevent separation of terminals 112.

The reliability and long-term stability of positive-locking fixation based exclusively on the clamping effect of the ligament system's braided structure can be further increased if at least one terminal 112a, 112b is additionally provided with a shaped surface region for fixation (e.g., shaped surface region 118a, shaped surface region 118b). The shaped surface region is a geometric modification formed on the surface of the terminal 112a, 112b that serves to improve positioning and fixation of the ligament system 120. The shaped surface region 118a, 118b may be implemented, for example, as a tapered portion (e.g., conical, frustum or other tapered portion) or stepped surface, or as a surface comprising grooves, serrations or recesses configured to receive one or more ligament portions 122 or other portions of the ligament system 120. According to an exemplary embodiment, the shaped surface region 118a, 118b comprises one or more grooves extending along the entire circumference of the terminal 112a, 112b into which the ligament system 120 is self-supportingly pressed as a result of its material structure and form-fitting characteristics, whereby the ligament system 120 is fixed to the terminal 112a, 112b in a positive-locking manner.

In one embodiment, as illustrated in FIG. 4, the shaped surface region 118a, 118b includes a generally tapered portion 124, 126 configured to be received within an end portion of the braided sheath such that the braided sheath bears against the tapered portions 124, 126. The braided sheath exerts a circumferential compressive force against the tapered portions 124, 126, wherein the fibers of the ligament system 120 contact the tapered portions 124, 126 to distribute pressure about the periphery of terminals 112a, 112b.

In this embodiment, the shaped surface region 118a further defines a fixing cavity 128 configured to receive a portion of the braided sheath and shaped surface region 118b defines a corner 130 into which a portion of the braided sheath seats. Thus, the braided ligament system 120 not only bears against the outer surface but also seats into the tapered portion 124 of terminal 112a and the tapered portion 126 of terminal 112b thereby increasing the positive-locking character and reinforcing the connection in terms of shape in addition to the clamping effect exerted. Further, the shaped surface region 118 a includes a step 132 to increase an effective cross-sectional dimension of the terminal 112a and the shaped surface region 118b includes a step 134 to increase an effective cross-sectional dimension of the terminal 112b, thereby increasing the tension within the fibers of ligament system 120 and the force asserted by the ligament system to urge the terminals 112 together.

The structural hold of the braided structure may, by itself, be sufficient to fix the ligament system 120 and thus hold the joint together and bear actuation and external loads. Nevertheless, further auxiliary fixing elements may be applied to strengthen fixation or for fiber end finishing. One typical auxiliary element is a simple fastening element 142 (e.g., a screw, bolt or other fastening element), preferably arranged on the terminal 112a, 112b approximately opposite the interface between the terminals, or at any point covered by the ligament system 120 (for example, but not limited to, at a shaped surface fixation region 118a, 118b), which fixes the surrounding fibers of the ligament system 120 by clamping when tightened. The fastening element 142 may also be used purely for finishing and fixing fiber ends, without contributing to the clamping force holding the joint together, while preventing fraying or unravelling of the fibrous structure (for example by clamping slightly fused (by thermal, adhesive or any other means) plastic fiber ends under a screw head). Without limitation, the ligaments 122 may further be fixed—either to reinforce fixation or for end finishing—by other methods as well, such as adhesive bonding or fusion into the surface of the terminal 112.

According to further embodiments, the ends of the fibers forming the ligament system 120 are in a fiber termination region 136 formed within the braid. Each fiber termination region 136 may be located in an inner portion of the braid, axially offset from the shaped surface fixation region 118a, 118b such that the fiber ends do not weaken the fixation zone and are positioned in a location protected from the repeated bending loads occurring during operation of the joint. Each fiber termination region 136 may comprise a knot, protrusion, or loop formed within the braided structure, or an element formed by external materials/effects such as molding or adhesives to inhibit fiber fraying. In some embodiments, a fiber termination region 136 may define a positive-locking interface configured to engage a fixing cavity formed in the respective terminal 112a, 112b. A fiber termination region 136 may define an aperture configured to permit a fastening element 142 to pass for one or more of further fixing the ligament system 120 to a terminal 112a, 112b or the attachment of a base body 116a, 116b to a respective terminal.

The joint structure may also comprise one or more connection interfaces at one or more terminals 112a, 112b (e.g., a non-articular surface). The connection interfaces can be configured for coupling further structural elements of the joint, for example a frame of a mechanical or robotic system containing the joint, or an object to be actuated. In the illustrated embodiment, a base body 116a is connected to terminal 112a and a base body 116b is connected to terminal 112b. Base body 116a or base body 116b may be, for example, an object to be actuated or a frame element (e.g., of mechanical or robotic system). An end portion of the base body 116a, 116b may be complementarily shaped to receive a corresponding terminal end; for example, tapered portions 124, 126 may be seated within base bodies 116a, 116b, respectively. Facing surfaces of respective base body and terminal may cooperate to define a clamping interface. This interface exerts a compressive force upon the ligament system 120, specifically across the contacted surface area of the fibers, to secure or reinforce the fixation of the ligament system 120. As shown in FIG. 4, for example, the inner surface 138 of base body 116a cooperates with the shaped surface region 118a to capture an end portion of the ligament system 120 therebetween and the inner surface 140 of base body 116b cooperates with the shaped surface region 118b to capture the opposite end portion of the ligament system 120 therebetween.

The base body 116a, 116b may be secured to its respective terminal 112a, 122b via one or more fastening elements 142, adhesive bonding, or other mechanical engagement. The mutually matching surface geometries or the number, position, and tensile forces of the fastening elements the arrangement of the fastening elements 142 may inhibit relative rotation or displacement of parts with respect to directions in non-intended degrees of freedom. The fastening elements 142 may be received through openings formed in either the base body or the terminal, which may optionally extend through a cartilage layer or articulation surface. Beyond primary fixation, a fastening element 142 may perform a secondary function, such as anchoring an independent component (e.g., a separately manufactured tendon system) via looping or knotting around the fastening element 142, or providing auxiliary securement of the ligament system 120 via over-braiding of the ligament system 120 or engagement with loops or buttonholes in the braided structure. To this end, in some embodiments, a region of a fastening element 142 may remain accessible through appropriately formed openings even after the base body and the terminal have been fixed to one another.

While FIG. 4 illustrates each terminal 112a, 112b attached to a single base body 116a, 116b, it is contemplated that a terminal may be attached to a plurality of base bodies, and conversely, a single base body may be attached to a plurality of terminals. Furthermore, any terminal or base body may comprise a multi-part assembly of separate components fixed to one another. In some configurations, a component may serve as a terminal for a first joint and simultaneously function as a base body for a second terminal, whether within the same or a different joint. In some embodiments, terminal 112a and base body 116a may form or be a portion of a first link of robotic skeleton and terminal 112b and base body 116b may form or be a portion of a second link of a robotic skeleton.

Since the base body 116a, 116b may partially or completely cover the shaped surface region 118a, 118b, the fixation regions of the ligaments are not necessarily located on the surface of the terminal 112a, 112b. In such cases, individual ligament portions 122 may emerge from defined locations (for example, defined at the contact boundary between the base body 116a, 116b and the respective terminal 112a, 112b) onto the outer surface of the terminal 112a, 112b and then connect to further structural elements of the structure, whether to another terminal, to another ligament portion, or to another structural element outside the joint. In such configurations, ligaments 122 may pass directly a fixation region, or may be routed via open or closed strap channels or by passing through open or closed ligament channels 144 or 146 formed in the terminal 112a, 112b—potentially requiring threading during the assembly process—and exit onto the outer or inner surface of the terminal through deflection slots 150, 152 functioning as defined exit points (examples of ligament channels are illustrated in FIGS. 8-9).

The ligament channel ends may function as new effective origin points for ligaments. That is, during operation of the joint, the portion of the ligaments 122 located predominantly outside the channels (e.g., outside of the area between a respective terminal 112a, 112b and base body 116a, 116b or clamping ring 148a, 148b) typically constitutes the primary active portion that mediates articulation and constrains relative motion of the joint. Nevertheless, the ligament segment disposed within the channel may also be configured to deform under load, including by elongation, bending, and/or conformational change responsive to tensile, torsional, or axial loading. After exiting the channel and emerging at an external surface of the respective terminal 112a, 112b, a ligament 122 may couple to additional structural elements as part of the ligament system 120.

A joint mechanism, such as joint mechanism 100, may include any suitable number, geometry, and arrangement of fixation regions and exit regions (or exit points), ligament channels, or deflection slots, selected in accordance with a desired structural configuration and functional performance. A given fixation region may be coupled to one or more exit points, and a given exit point may be coupled to one or more fixation regions, such that the ligament system 120 may branch, merge, or be rerouted relative to the exit points. Branching or merging of ligament portions 122 may be provided outside the joint or within the joint, including within an interfacial clamping region defined between cooperating surfaces of the terminal, a clamping sleeve, and a base body, thereby enabling plural ligament architectures and load-path topologies.

In some embodiments, a single exit point may be configured to connect and/or provide passage for one or more ligament portions to a corresponding terminal. Further, a single fixation region may be configured to secure one or more ligament portions, to define a terminal end location for a ligament portion, or define a fixation-through arrangement in which a ligament portion 122 is fixed at the fixation region while still extending beyond the fixation region as part of a continuous ligament structure.

The positive-locking connection between the ligament system 120 and one or more terminals 112 may be further reinforced by one or more fixing elements 154 coupling the ligament system 120 to at least one terminal 112. A fixing element 154 is configured to supplement the positive-locking fixation of the braided-structure sheath with mechanical support. A fixing element 154, as illustrated in FIG. 4, may be a protrusion that positively engages a given portion of the ligament system 120 at a defined point of a terminal 112. The fixing element 154 may, for example, be a thickened portion incorporated between, or formed from, the braided ligament portions, such as an end knot or a braided lug. In other embodiments, a fixing element 154 may be a rigid insert or other rigid structure, such as, but not limited to an over-molded feature. Different types of fixing elements may be used on various ligament portions 122. A fixing element 154 may engage a shaped surface region of a terminal, such as a fixing cavity (e.g., fixing cavity 128, 130 formed in the terminal 112. A fixing cavity 128, 132 may be, for example, a cylindrical, conical or buttonhole-like depression providing a tight-fitting engagement required for the positive-locking connection. The fixing element 154 may be of an end-terminating type, which at the same time finishes the fibers of the associated ligament portion 122, thereby forming an end point on the ligament system 120, or may be of a continuous type, which does not interrupt the ligament structure but, after providing fixation, allows the contained ligament portion 120 to pass through.

In some embodiments, one or more clamps (e.g., a clamping sleeve, clamping ring, band, or other circumferential retention member) may be disposed on, and fitted about, one or more terminals. For example, in the embodiment illustrated in FIG. 2-5, a clamping ring 148a is fitted onto the outer circumference of the shaped surface region 118a of terminal 112a and a clamping ring 148b is fitted onto an outer circumference of the shaped surface region 118b of terminal 112b. Each clamping ring 148a, 148b may be formed of any suitable material, including, by way of non-limiting example, spring steel, wire, rigid polymeric material, rubber band, and/or a textile-based elastic braid.

In operation, the clamping ring 148a, 148b applies a circumferential compression (e.g., around the perimeter) in a ring-like manner to the ligament system 120, thereby urging the ligament system 120 inward against the corresponding terminal 112a, 112b. This peripheral clamping action provides supplemental fixation and can increase stability of the ligament-to-terminal interface, particularly under elevated load conditions. In some embodiments, the clamp functions as a redundant retention mechanism in addition to the positive-locking fixation provided by the braided structure and may be especially advantageous where the joint is subjected to periodically occurring and/or dynamic loading (e.g., cyclic bending, torsion, or impact loads) and enhanced resistance to relative slip, loosening, or migration of the ligament system 120 is desired.

According to one embodiment, the ligament system 120 is configured such that an inclination angle of the braided fibers decreases under load, thereby contracting the sheath in a radial direction. This structure achievable by braiding allows the ligament system 120 to contract radially under bending or tensile loading, thereby increasing the clamping effect exerted on the surfaces of the terminals 112. A characteristic of a braid having such a fiber arrangement is that the internal structural stress and the change in the inclination angle of the fibers dynamically vary as a function of the external mechanical load, such that fixation is not static but varies with the operating state of the joint. The same effect allows for the fixation, and therefore the joint, to be kept under constant tension, reinforcing the coupling and ensuring properly constrained motion.

FIG. 9A, FIG. 9B and FIG. 9C (collectively FIG. 9) illustrate such operation according to one embodiment. The joint mechanism 100 is illustrated in three different states—an extended state (FIG. 9A), a partially bent state (FIG. 9B) and a fully bent state (FIG. 9C). In the illustrated embodiment, the ligament system 120 formed as a braided-structure sheath conforms increasingly tightly to the terminals 112 as bending progresses, thereby passively increasing the axial and lateral stiffness of the system in the end positions of movement. In particular, ligament 122a, which will be referred to the anterior ligament for the sake of the example, increasingly conforms to outer curvature of terminal 112a. This operating mechanism enables an enhanced fixing and stabilizing function of the ligament system 120 during peak loads occurring during bending, while in the initial state the system exhibits lower resistance and more compliant behavior.

In some embodiments, the braided structure of the ligament system 120 includes, within a region allowing free movement between the terminals 112, at least one ligament 122 branch. Instead of a fully enclosing cylindrical or spherical braided capsule, at least one strap portion may be formed (e.g., as ligaments 122), for example in a C-shape around the joint, with an opening on one side. Similarly, two or more strap portions can also be formed, on one, two, or more sides of the joint. Such branches can create multiple parallel or crossing paths and load lines, enhancing structural stability and improving distribution of torques and forces during motion. Branching strap structures may be created in multiple regions. The branches may be formed during the braiding process, such that the use of separate connection points or node reinforcements is not required.

If terminals 112 distract (move apart In the illustrated embodiment, the joint 101 may allow a complex motion such as a primary rotation for flexion/extension coupled with a constrained axial rotation of terminal 112a or 112b that may be functionally dependent on the degree of flexion and further supported by arthrokinematic glides to maintain surface congruence. Further, the flexion movement may be characterized by a movement comprising a simultaneous posterior roll and a reciprocating anterior glide of terminal 112a relative to terminal 112b. This motion is facilitated by the asymmetric curvilinear geometry of the articular surfaces and is constrained by the ligament system 120 to ensure a transition from a rolling-dominant phase in early flexion to a gliding-dominant phase in terminal flexion.

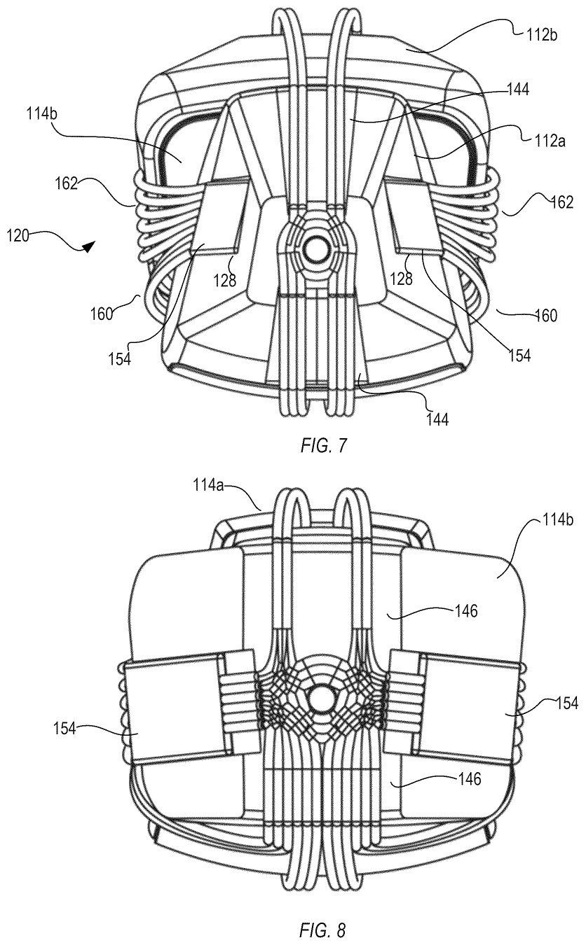

The ligament system 120 includes side ligaments that provide lateral (e.g., lateral-medial) stability in the extended state. Ligament system 120 may have a preload to assert a coaptive force on the terminals 112a, 112b, pulling them together to generate a frictional engagement that may resist off-axis lateral displacement, maintain kinematic centration of the articular projection within its receiving surface, or otherwise enhance stability or prevent undesired translation or dislocation. As the joint flexes, tension in the anterior ligament 122a increases, which may result in increased coaptive force and further the constricting clamping effect on the terminals 112. The ligament 122a helps pull terminal 112a forward (anterior glide) while increasingly resisting undesired off-axis displacement as the side ligaments become increasingly lax. FIG. 7 illustrates a first end view of one embodiment of the coupled terminals 112a, 112b and FIG. 8 illustrates a second end view of one embodiment of the coupled terminals 112a, 112b. In FIGS. 7 and 8, the ligament system 120 is schematically depicted in a fibrous representation, with the braided construction itself omitted for clarity. The depiction is provided to illustrate that, in certain regions of the braid, a comparatively higher fiber density is formed (e.g., regions 160), whereas in other regions a comparatively lower fiber density is formed (e.g., regions 162), thereby providing, for example, increased stability in selected sections and increased flexibility in other sections. In some embodiments, localized modifications of fiber geometry, including, without limitation, changes in fiber inclination angle, fiber direction, or fiber crossing topology (including fan-shaped arrangements) or other geometric and material parameters, permit spatially differentiated tuning of the mechanical response of the ligament system, such as shear resistance, bending compliance, or axial elongation.

Thus, the ligament system 120 is configured such that different regions thereof have different braiding densities, different braiding patterns, and different fiber tensions or compactness. This can enable local optimization of the mechanical behavior of the ligament system 120, such that, in certain regions, elongation and conformational effects and movement-range limitations may occur in different manners or to different extents, considering different load directions and operating states of the joint. The ligament system 120 may incorporate various features discussed in conjunction with ligament system 20, such as, but not limited to, additional functional elements such as described in conjunction with FIG. 1.

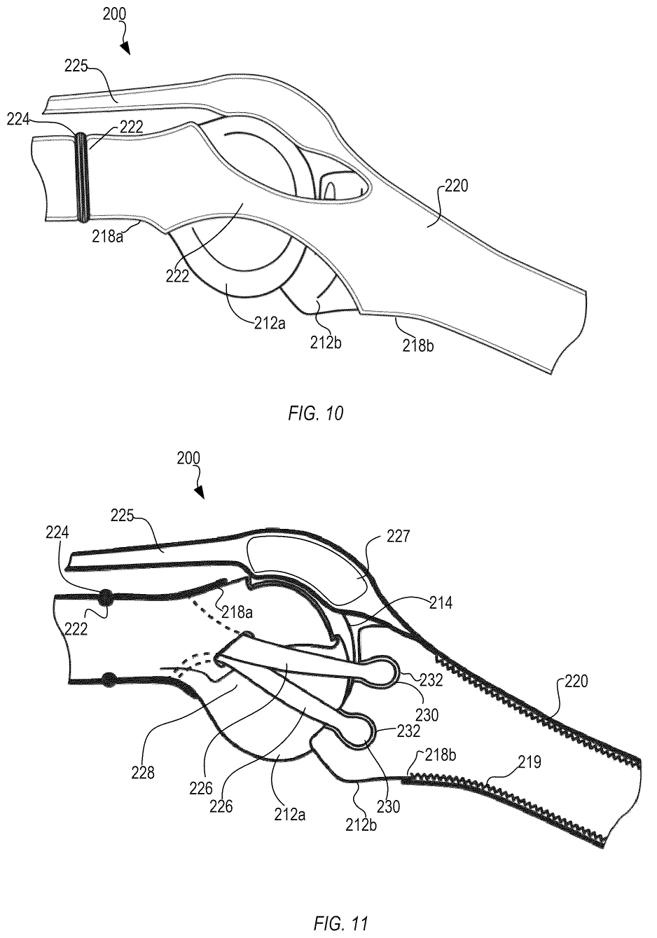

As discussed, various embodiments may use multi-layer sheaths, including multiple ligament systems arranged in layers or a ligament system having inter-braided or otherwise attached layers. FIGS. 10 and 11 illustrate another embodiment of a joint mechanism 200 in side view and longitudinal sectional view, in which the structure of one embodiment of a multi-layer, mutually inter-braided ligament system 220 is observable. More particularly, FIGS. 10-11 show an example knee-like joint mechanism with two terminals 212a, 212b, which are connected by the ligament system 220 configured as a braided-structure sheath, making use of the conical or other tapered geometry of shaped surface fixation regions 218a, 218b for fixation using the clamping force of the braided sheath. On terminal 212a, the shaped surface fixation region 218a includes a tapered portion to which ligament system 220 form fits and circumferential fixing groove 222 into which a clamping ring 224 is pressed to assist fixation. On terminal 212b, the shaped surface fixation region 218b includes a tapered portion to which ligament system 220 form fits and an area of increased roughness (e.g., Ra value) 219 to enhance the frictional fit between the ligament system 220 and circumferential fixation region surface. The area of increased roughness may, for example, be a knurled or otherwise textured or roughened surface in some embodiments.

The joint mechanism 200 thus comprises a coupling element 225 that serves to actuate the joint mechanism, for example as a pulling tendon that transmits motion energy, imitating natural tendons. In other words, the coupling element 225 may be formed as a tendon and serve to move terminals 212 relative to one another. Thus, for example, the coupling element 225 may imitate the quadriceps tendon. The coupling element 225 may be a coupling element as discussed in conjunction with FIG. 1 that connects at one end to the ligament system 220 (e.g., by an end knot or other mechanism) and at the other end to an external actuator (not shown), non-limiting examples of which are discussed above. In some embodiments, the coupling element 225 is braided directly into the textile structure of the ligament system 220 itself.

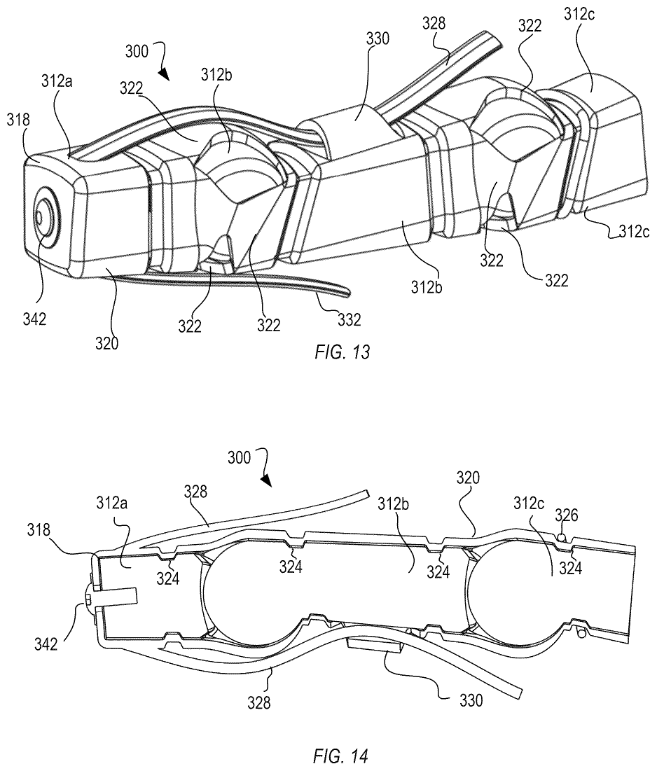

The ligament system 220 may comprise at least one guiding part formed as a loop or a feed-through opening and providing passage for the coupling element 225, the guiding part may be integrated into the braided structure of the ligament system 220. Non-limiting examples of guiding parts are illustrated in FIGS. 13, 14, 16, 23, 24. According to one embodiment, the guiding part is formed in the braided structure of the ligament system 220, for example by locally modifying the directed braiding pattern of the individual fibers, such that one or more suitably positioned and dimensioned loops, loop series or feed-through openings are formed in the original fiber lattice. In one embodiment, the coupling element 225 or other portion of the ligament system 220 includes an insert 227. The insert 227 may be formed by over-braiding, which reproduces the force-arm-increasing function of, for example, a patella, supplemented by a connecting element 225.

In this embodiment, the ligament system 220 further includes cruciate ligaments 226, which branch from an inner surface of a multi-layer sheath and are guided into the interior of the joint through deflection slot 228 and fixed by fixing element 230 in fixation cavities 232 formed for this purpose. Non-limiting examples of fixing elements are discussed in conjunction with fixing element 154. The embodiment further comprises a cartilage layer 214, non-limiting examples of which are discussed above.

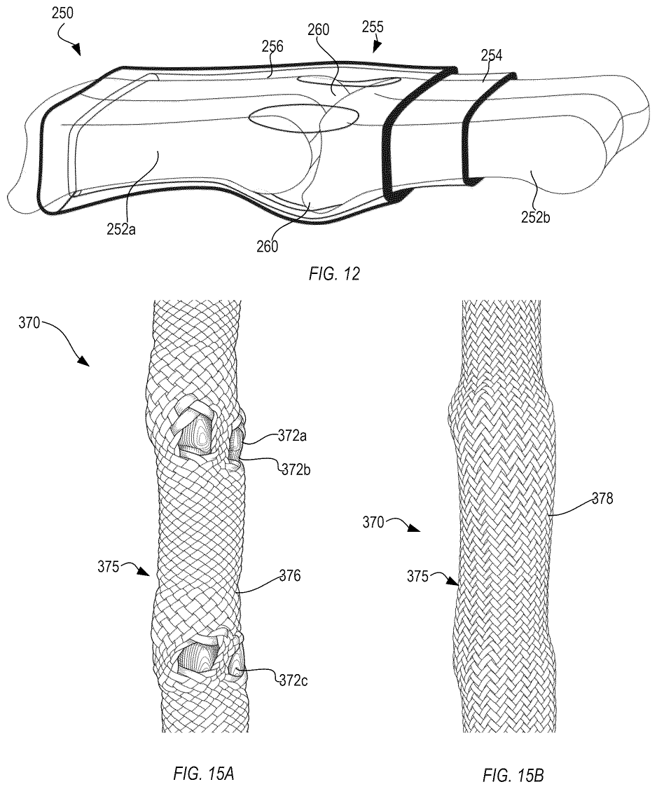

FIG. 12 illustrates another example embodiment of a joint mechanism 250. Two terminals 252a, 252b (generally terminals 252) are connected by the ligament system 255, which is illustrated as transparent in FIG. 12 to better illustrate various layers. In the illustrated embodiment, the ligament system 255 includes inner braided-structure sheath 256 and outer braided-structure sheath 258. While two layers are illustrated, a multi-layer ligament system 255 may comprise additional layered sheaths (e.g., three, four, etc.). According to one embodiment, the inner sheath 256 provides strength for keeping the terminals together as ligaments, while the outer sheath 258 provides additional structural stability, wear protection or other functional roles, such as sensor support or electrical shielding.

Each layer (e.g., inner sheath 256 and outer sheath 258) may comprise interlaced braided fibers, which may be made of various materials, non-limiting examples of which are discussed above in conjunction with ligament system 20. Depending on geometric routing, a sheath (e.g., inner sheath 256 and outer sheath 258) may be regularly braided, asymmetrically meshed, or branching. For example, inner sheath 256 defines ligament portions 260. The geometric and material properties of ligament system 255 may be tailored to define a specific range of motion and stiffness profile for the joint and to provide for regional modulation of mechanical and structural properties.

The terminals 252 may include shaped surface regions for fixation, such as a tapered portion (e.g., conical, frustum or other tapered portion) or stepped surface, or a surface comprising grooves, serrations or recesses configured to receive a portion of the ligament system. On terminals 258, inner sheath 256 may form fit to a shaped surface region that enhances fixation and a corresponding area of outer sheath 258 may form fit to the inner sheath 256. Further, some embodiments may employ secondary clamping mechanisms such as clamping rings that seat in grooves or other indents or other fastening elements to further affix the inner sheath 256 or outer sheath 258 to the terminals 252.

In some embodiments, two or more braided structure sheaths (e.g., inner sheath 268 and outer sheath 258) of a multi-layer ligament system are concentrically arranged. In further embodiments, two or more braided-structure sheaths (e.g., inner sheath 268 and outer sheath 258) of a multi-layer ligament system are at least partially braided into one another, for example via common nodes, by changing the braiding pattern while braiding multiple layers in parallel in one manufacturing process, or by overlapping loop formations. As a result, the structure does not merely form a layered arrangement, but rather a coherently integrated unit that is capable of providing complex mechanical responses to applied loads and other varying conditions.

As discussed above, embodiments may connect a plurality of mutually articulated terminals, for example forming three-member or more joint chains, joints comprising more than two terminals, anthropomorphic finger structures or other complex mechanical systems. FIG. 13 illustrates a bottom view, from the viewpoint of bending, of one embodiment of a joint mechanism 300 connecting three terminals 312a, 312b, 312c (generally terminals 312). FIG. 14 shows a longitudinal sectional view of one embodiment of a joint mechanism 300, in which it is clearly visible that a continuous ligament system 320 follows the contours of the structure with varying geometry along the different terminals 312.

The terminals 312 are structurally and functionally defining articulated components adapted to move relative to one another and may be made of various materials depending on implementation, non-limiting examples of which are described above. In certain embodiments, the joint mechanism 300 may integrate one or more cartilage layers improving friction properties or wear resistance.

The terminals 312 are connected by the ligament system 320, which is formed as a braided-structure sheath that, in some embodiments, forms a cylindrical or spherical-shell-like capsule around the terminals 312. Ligament system 320 may be formed and function similarly to as discussed with respect to other embodiments but is adapted for terminals 312.

In illustrated embodiment, the ligament system 320 connects the terminals 312 by means of a plurality of ligament branches 322 (including ones on the opposite side of joint mechanism 300) and overlapping braiding zones, thereby ensuring mechanical coupling and the desired freedom of movement. Thus, in addition to establishing the mechanical connection, the ligament system 320 also provides freedom of movement between the terminals 312, while at the same time restricting their displacement in predetermined directions, thereby simultaneously fulfilling connecting, actuating and stopping functions.

Ligament system 320 asserts a directed clamping effect that conforms to the shape of the terminal surface geometry and may establish stable fixation thereon by positive-locking engagement. As discussed above, the clamping effect is based on the braided structure. The geometric and material properties of ligament system 320 may be tailored to define a specific range of motion and stiffness profile for the joint and to provide for regional modulation of mechanical and structural properties. In certain embodiments, the braided architecture is configured to undergo radial constriction during joint articulation (e.g., bending), which increases the circumferential compressive force distributed across the contact area of the terminal and can facilitate a progressive stiffening of the ligament system to provide an integrated passive motion constraint. In certain embodiments, ligament system 320 is configured.

In certain embodiments, the ligament system 320, in at least one geometric state of the joint mechanism 300, attaches in a positive-locking manner to the surface of at least one terminal 312 due to the clamping effect of the braided structure. In some embodiments, fixation is not provided by separate mechanical parts or assembly steps, but solely by the engagement of the braided sheath with the at least one terminal 312. However, other embodiments may use auxiliary fixing mechanisms. Depending on the particular embodiment, this positive-locking fixing function may be exerted in different ways and in different states. In some embodiments, the braided-structure sheath may have sufficient pretension in the initial position or rest position to clamp onto the terminals 312 having the corresponding geometry to form a mechanical engagement such as a form-fit, friction fit or combination thereof.

In some embodiments, the ligament system 320 may only tighten sufficiently in certain operating states to achieve positive lock fixation. In such cases, ligament portions 322 may be looser relative to the terminal 312 in the rest state, but when the mechanism moves or is loaded externally and the ligament system is placed under load (e.g., pulled, rotated, or axially tensioned), internal pressure increases and fibers apply distributed pressure over the contact area of the terminal 312, increasing with the load. The clamping effect may in certain cases be minimal when the joint is unloaded, though the structure of ligament system 320 may have sufficient tension to prevent separation of terminals 312.

The ligament system 320 is formed as compressive braided sheath that applies a compressive force along the perimeter of the terminals 312 and may be positively fixed through clamping force, for example, to shaped surface fixation region 318 of terminal 312a (e.g., which creates a large step in cross-section), which nests in the ligament system 320. Further, the terminals 312 include circumferential fixing grooves 324. As a result of tensile forces and circumferential contraction inherent to the braided structure, the braided structure sheath is urged radially inward against the surfaces of the terminals and thereby conforms-to surface grooves 324 or recesses formed therein. This forced conformation causes portions of the sheath to seat within the grooves, creating additional positive locking engagement defined by the interacting geometries of the braided sheath and the terminal-surfaces. Additionally or alternatively, clamping rings can be pressed into one or more of the grooves 324 to assist fixation (e.g., clamping ring 326 is illustrated). Fastening elements may be used to further assist fixing the ligament system to one or more of the terminals. In the illustrated embodiment, for example, fastening element 342 may further assist in fixing the ligament system 320 to terminal 312a. Embodiments may include one or more cartilage layers between the terminals.

The ligament system 320 includes tendon coupling elements 328 and their guiding portions 330, which may be integrated into the multiple layers, thereby providing additional functional layering. The coupling elements 328 and guiding parts 330 may respectively be coupling elements and guiding parts as discussed in conjunction with FIG. 1 or other embodiments. The coupling elements may, for example, connect at one end to the ligament system 320 (e.g., by an end knot or other mechanism) and at the other end to an external actuator (not shown), non-limiting examples of which are discussed above, or a support structure. In some embodiments, one or more of the coupling elements 328 is braided directly into the textile structure of the ligament system 320 itself. During the manufacturing process, threading through the guiding parts 330 may also take place. Such embodiments can result in an even higher degree of integration of the manufacturing process and a further significant reduction of assembly requirements. Thus, in some embodiments, the coupling elements 328 and guiding parts 330 may be produced with a ligament system as a uniform integrated structure.

According to one embodiment, the configuration of each guiding part 330 allows rapid threading and unthreading of the respective coupling element 328. Further, the guiding part 330 may be braided directly into the textile structure of the ligament system 320 or be otherwise provided. Thus, a coupling element 328 may be integrated into the braided structure of the ligament system 320 by, for example, being produced as part of the ligament system 320 in a single process as a uniform structure to benefit from the same load-distribution property on the fibers as the ligaments connecting the terminals, instead of being formed as a separate external element and then attached.

FIG. 15A and FIG. 15B illustrate another embodiment of a joint mechanism 370 that comprises a chain of joints. Joint mechanism 370 includes terminals 372a, 372b, 372c (generally terminals 372) connected by a ligament system 375. While the terminals 372 are illustrated as 3D printed parts, terminals 372 may be formed by other techniques in other embodiments. In the illustrated embodiment, ligament system 375 includes an inner sheath 376 covered by an outer sheath 378. Ligament system 375 may be similar to ligament system 255 but acts as a ligament system for a chain of joints (e.g., the joint at the interface of terminal 372a and terminal 372b and the joint at the interface of terminal 372b and terminal 372c).

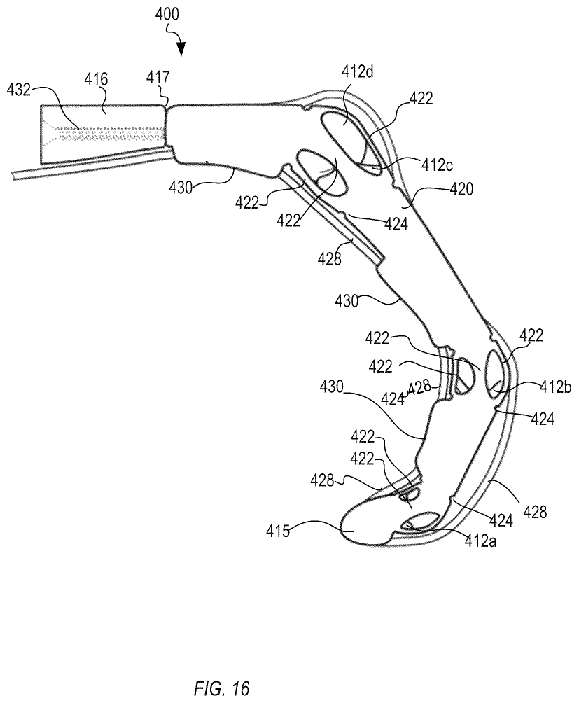

FIG. 16 illustrates one embodiment of a humanoid robotic finger 400, which may be one embodiment of a joint mechanism 10. Robotic finger 400 comprises four terminals 412a, 412b, 412c, 412d (generally terminals 412) (e.g., bones) connected by a continuous layered ligament system 420. The terminals 412 function as finger bones and are adapted to move relative to one another. Terminals 412 may be made of various materials depending on implementation, non-limiting examples of which are described above. In certain embodiments, the robotic finger 400 may integrate one or more cartilage layers improving friction properties or wear resistance.

The terminals 412 are connected by the ligament system 420, which is formed as a braided-structure sheath that forms a cylindrical or spherical-shell-like capsule around the terminals 412. The ligament system 420 may cover the terminals 412 in one piece and may be a multi-layered ligament system that incorporates tendons and connects multiple joints 412. Ligament system 420 comprises interlaced braided fibers, which may be made of various materials, non-limiting examples of which are discussed above in conjunction with ligament system 20 and may function similarly to as discussed above with respect to other embodiments but is adapted for terminals 412. Depending on geometric routing, the ligament system 420 may be regularly braided, asymmetrically meshed, or branching, such that in some zones ligament portions 322 overlap or branch from each other.

In the illustrated embodiment, the ligament system 420 connects the terminals 412 by means of a plurality of ligament branches 422 (including ones on the opposite side of finger 400 (not shown)) and overlapping braiding zones, thereby ensuring mechanical coupling and the desired freedom of movement. Thus, in addition to establishing the mechanical connection, the ligament system 420 also provides freedom of movement between the terminals 412, while at the same time restricting their displacement in predetermined directions, thereby simultaneously fulfilling connecting, actuating and stopping functions.

The ligament system 420 may comprise multiple layers and branch in a manner analogous to anatomical ligaments, such the ligament system 420 responds in a differentiated manner to bending, extension and torsion. Thus, the degrees of freedom of movement between the terminals 412 may be rich, similar to natural human joints. The braid structure of ligament system 420 may include portions that imitate one or more of the proper collateral ligaments (PCL), accessory collateral ligaments (ACL), the palmar ligament, the oblique retinacular ligament, Cleland's ligament, or Grayson's ligament.

In the illustrated embodiments, the ligaments 422 around the joints do not overlap with each other and are formed by creating engineered openings through a single tubular layer of braid. The coupling elements 428 do overlap other braided structures. In other embodiments, for example, the ligaments or other portions of the braided structure may overlap. For example, the ligament system 420 may include another layer of ligaments that overlap ligaments 422, or a continuous covering. As another example, the ligament system 420 may include a continuous braided outer sheath.

Ligament system 420 asserts a directed clamping effect that conforms to the shape of the terminal surface geometry of terminal 412a at fingertip 415 and further follows the contours of the terminals 312 with varying geometry along the different terminals. As discussed above, the clamping effect is based on the braided structure. The geometric and material properties of ligament system 420 may be tailored to define a specific range of motion and stiffness profile for each joint in finger 400. In certain embodiments, the braided architecture is configured to undergo radial constriction during joint articulation (e.g., bending), which increases the circumferential compressive force distributed across the contact area of the terminals. This radial constriction may facilitate a progressive stiffening of the ligament system 420 as a joint approaches the limits of its kinematic envelope, thereby providing an integrated passive motion constraint. In certain embodiments, ligament system 420 is configured to provide for regional modulation of mechanical and structural properties.

In certain embodiments, the ligament system 420, in at least one geometric state of the finger 400, attaches in a positive-locking manner to the surface of at least one terminal 412 due to the clamping effect of the braided structure. In some embodiments, fixation is not provided by separate mechanical parts or assembly steps, but solely by the engagement of the braided sheath with the at least one terminal 412. However, other embodiments may use auxiliary fixing mechanisms. Depending on the particular embodiment, this positive-locking fixing function may be exerted in different ways and in different states. In some embodiments, the braided-structure sheath may have sufficient pretension in the initial position or rest position to clamp onto the terminals 412.

In some embodiments, the ligament system 420 may only tighten sufficiently in certain operating states to achieve positive lock fixation. In such cases, strap portions 422 may be looser relative to the terminal 412 in the rest state, but when the mechanism moves or is loaded externally and the ligament system is placed under load (e.g., pulled, rotated, or axially tensioned), internal pressure increases and fibers apply distributed pressure over the contact area of the terminal 412, increasing with the load. The clamping effect may in certain cases be minimal when the joint is unloaded, though the structure of ligament system 420 has sufficient tension to prevent separation of terminals 412.

The ligament system 420 is formed as compressive braided sheath that applies a compressive force along the perimeter of the terminals 412 and may be positively fixed through clamping force, for example, to shaped surface fixation region of terminal 412a (e.g., fingertip 415), which nests in the distal end ligament system 420 (the fingertip end). Further, the terminals 412 include circumferential fixing grooves 424 into which clamping rings can be pressed to assist fixation. Fastening elements may be used to further assist fixing the ligament system to one or more of the terminals.

In some embodiments, the ligament system 420 is braided so that the fibers terminate near end 417. The fiber ends may, for example, be clamped between terminal 412d and a base body 416 and, which may be connected to the terminal 412d by one or fastening elements (e.g., fastening element 432) or other mechanism. The fiber ends may also be terminated in other manners.

The ligament system 420 includes tendon coupling elements 428 and guiding parts 430, which may be integrated into the multiple layers, thereby providing additional functional layering. The coupling elements 428 and guiding parts 430 may respectively be coupling elements and guide parts are discussed in conjunction with FIG. 1 or other embodiments. The coupling elements may, for example, connect at one end to the ligament system 420 (e.g., by being directly braided together in the same process, or by an end knot or other mechanism) and at the other end to an external actuator or a support structure. In some embodiments, one or more of the coupling elements 428 is braided directly into the textile structure of the ligament system 420 itself. In the illustrated embodiment, for example, the coupling elements provide a flexor digitorum profundus (FDP) on the palm side for bending and the extensor digitorum communis (EDC) with an integrated branching structure on the other side. Embodiments may include additional tendons, such as the flexor digitorum superficialis (FDS) or additional sections of the anatomical extensor network.

According to one embodiment, the ligament system 420 comprises at least one guiding part 430 formed as a loop or a feed-through opening and providing passage for a coupling element 428. The guiding part 430 may be integrated into the braided structure of the ligament system 420. The guiding part 430 may be formed in the braided structure of the ligament system 420, for example by locally modifying the directed braiding pattern of the individual fibers, such that one or more suitably positioned and dimensioned loops, loop series or other feed-through openings are formed in the original fiber lattice.

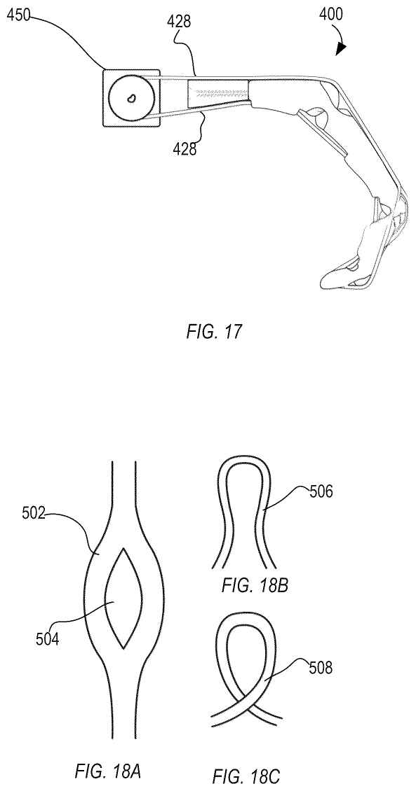

FIG. 17 illustrates one embodiment of finger 400 connected to an actuator 450. By driving actuator 450, the finger 400 may be flexed or extended.

As discussed above, embodiments of ligament systems (e.g., ligament system 20, 120, 220, 320, 420) include separately formed structures that can be attached to the ligament system. FIG. 18A, FIG. 18B and FIG. 18C illustrate embodiments of example structures (referred to as fixation parts) that may be formed on the ligament systems to help attachment to external bodies. In the embodiment of FIG. 18A, an attachment structure is provided in the form a braided portion 502 of the ligament system, where the portion defines a buttonhole 504 to which an external body can be attached; in FIG. 16B, a standard braided loop 506 forms an attachment part; and in FIG. 16C a twisted loop 508 forms an attachment part. The attachment parts may tighten under load to enhance fixation of the external body.

As further discussed, embodiments may incorporate guiding parts. Guiding parts (e.g., guiding parts 26, 230, 330, 430, 730 or other guiding parts) are preferably configured such that they do not weaken the structural integrity of the ligament system. More particularly, it is preferable that a guiding part forms a feed-through point at the desired location while maintaining fiber-directional continuity, without knotting or cutting of fibers. Such local modification of the braiding pattern allows precise positioning and dimensioning of the guiding part, including its diameter, opening angle and axial orientation.

The size and shape of a guiding part may vary depending on the desired type of the coupling element. For a coupling element having a smaller diameter, formation of a simple braided loop may be sufficient, whereas for a coupling element intended to transmit a larger diameter or higher tensile forces, formation of a multilayer or spirally reinforced guiding part may be required. The guiding parts may additionally be suitable for secondary point-like fixation of ligaments, for example by being hooked onto surface protrusions of the terminals or onto fastening elements, either during the braiding process or during assembly.

According to one embodiment, a ligament system (e.g., ligament system 20, 120, 220, 255, 275, 320, 420, 720 or other ligament system) is formed in a single braiding operation such that it is braided directly and continuously onto the surface of the terminals (direct over-braiding). This solution makes it possible to create the entire terminal/ligament system assembly, without separate assembly or joining steps post-fabrication of the ligament system. During the braiding operation, the terminals (e.g., terminals 12, 112, 212, 312, 252, 272, 412 or other terminals) are fixed in their spatial positions, typically by being connected to a pre-set jig or a rotary fixture. This ensures that, during braiding, the terminals remain within the prescribed angular range and in the desired relative and absolute arrangement, such that the ligament system is formed with the intended geometric configuration. In other embodiments, a ligament system of one or more layers may be formed in multiple operations. In a multiple layer ligament system, for example, the layers could be formed serially by the same machine or concurrently or serially by multiple braiding machines.

A suitable braiding-based manufacturing process may be realized, for example, using over-braiding (mandrel over-braiding) or 3D braiding known to the skilled person, and/or a combination of these methods. The braiding may be carried out without additional insert elements, or in such a way that a chain of terminals participating in the joint mechanism (which may comprise multiple joints, base bodies, and the like) or a temporary mandrel is gradually guided through a defined point of the braiding machine, and the braiding is performed such that the prepared chain is positioned within the braid-forming region, thereby allowing the fibers to be braided around it. The structure may be realized using any device suitable for braiding, including, without limitation, maypole braiding, lace braiding, variation braiding, Cartesian braiding equipment, or manual or manually assisted braiding using frames, provided that these involve moving fibers along planned, potentially modifiable paths, typically with mutual crossing of the fibers. For example, in variation braiding, horn gears move braiding heads (carriers) carrying individual fibers and provided with length-compensation mechanisms for fiber tensioning, along predefined paths that can be modified in a programmable manner by switches, in a manner characteristic of maypole braiders. With suitable equipment, reversal of the fibers is also achievable, thereby forming loops or cover regions perpendicular to the braiding direction without end finishing. For the purpose of forming openings and branches of the ligament system (e.g., ligament system 20, 120, 220, 320, 355, 375, 420, 720, or other ligament system), the paths travelled by the fibers and the structures created are organized so as to cause separations and mergers between individual intersecting fiber groups, thereby locally splitting the workpiece under manufacture into multiple parts or, conversely, merging them into a single structure.

In manufacturing a ligament system (e.g., ligament system 20, 120, 220, 320, 355, 375, 420, 720, or other ligament system), the geometry formed during the braiding process can be adapted to the desired mechanical properties. The braiding pattern may be applied to parts of, or to the entirety of, the ligament system. Non-limiting examples of braiding patterns include:

A biaxial braid, in which the fibers are oriented at braiding angles ±θ° with respect to the longitudinal axis of the braided structure. This longitudinal axis may be defined as the 0° reference line and may be coaxially aligned or parallel to the primary axis of the 3D braiding machine during braiding. The braiding angle θ is selectively tunable during the braiding process to achieve a predetermined braid density or a specific mechanical performance profile. In some embodiments, the fibers are braided at approximately ±45° (that is, a first set of fibers at a nominal +45° braiding angle are interwoven with a second set of fibers at a nominal −45° braiding angle). As used herein in the context of braiding angles, “approximately” accounts for inherent manufacturing tolerances, machine vibration, and carrier tension variances typical of braiding machinery. This configuration provides excellent flexibility with respect to bending, while exhibiting limited axial stiffness, and may therefore be preferred, in some embodiments, in mechanisms imitating a metacarpophalangeal joint, in which bending constitutes the dominant movement. It should be understood that ±45° is merely one embodiment, and biaxial braids using other braiding angles may be used.

In further embodiments, the structure may comprise a triaxial braid. In a triaxial braid, a third fiber group is integrated into the interwoven ±° fibers. These longitudinal fibers (also referred to as axial or “0°” fibers) extend approximately θ parallel to the longitudinal axis of the braided structure. Specifically, the longitudinal fibers are oriented at a nominal 0° angle. This arrangement increases axial stiffness and has a favorable effect on tensile force transmission, for example in applications imitating a knee joint, though a triaxial braid may be used for a variety of applications.

A twisted rope, or a spiral or helical braid, having a twisted configuration in which the fibers are laid in a single direction with continuous twisting, which may be particularly advantageous under torsional loading, as the structure is better able to accommodate and control twisting movements.

The properties of the braiding pattern, such as the inclination angle, the spiral pitch, the spacing of crossing points, the fiber tension and the braid density, are all defined as freely selectable parameters during the manufacturing process. Control of the braiding apparatus allows these parameters to be set differently in different regions of the joint mechanism, for example such that a pattern providing greater flexibility is formed on a lateral side of the joint, while a pattern providing greater stiffness is formed on a dorsal side thereof.

The selection of the fiber material also plays a significant role in setting the mechanical response. The fibers of the ligament system may be made, for example, of high-load-bearing aramid-based fibers (for example Kevlar), technical polyester or polyamide, ultra-high-molecular-weight polyethylene (UHMWPE, for example Dyneema), glass fibers, carbon fibers, or various elastomer-based yarn structures or rubber strands. These materials may also be combined as desired. For example, a ligament system (e.g., ligament system 20, 120, 220, 320, 420, or other ligament system) may be braided using a wear-resistant fiber as an outer layer, while fiber groups having a high modulus, low friction-coefficient, and high load-bearing capacity are braided into the inner structure. Differences in mechanical parameters on a fiber-by-fiber and region-by-region basis enable the formation of biomechanically differentiated behavior, similarly to biological joints, in which different tissues participate in force transmission and movement limitation.

During the formation of the ligament system e.g., ligament system 20, 120, 220, 320, 420, 720, or other ligament system), various fiber materials may be used, the selection of which can be adapted to the desired mechanical, functional and manufacturing-related requirements. The base material of the fibers used fundamentally determines the flexibility, shape retention, wear resistance and long-term structural stability of the braided structure. In addition, the fiber composition also influences the fixation properties of the ligament system, in particular with respect to its fitting to the surface of a terminal.

It is preferred, in some embodiments, if the braided fibers are made of thermoplastic polymers, elastomers or composite fibers. Thermoplastic polymers, such as certain types of polyester (PET), polyamide (PA) or polypropylene (PP), have the advantage that these fibers can also be shaped retrospectively by a thermoforming process after final assembly of the joint. By means of such thermoforming, the braid can be fitted more closely to the contour of the terminals over the desired surface of the ligament system, which may be the entire surface (accounting for gaps in branches or other engineered openings in the ligament system) and the mechanical cohesion of the fibers can also be increased, thereby enhancing both the clamping effect and the reliability of the form-fitting connection. This property of thermoplastic fibers is particularly advantageous in applications in which subsequent adjustment or fixation of the joint mechanism is required. Highly thermoformable fibers can facilitate forming rigid or semi-rigid regions on the ligament system.

When elastomer-based fibers—such as thermoplastic polyurethane (TPU), silicone rubber or ethylene-propylene-diene monomer (EPDM)—are used, the ligament system is capable of undergoing a substantial degree of deformation while retaining its ability to return to its original shape. As a result, embodiments of spring-like ligament systems can be realized that allow large deformations under external tensile or bending loads yet return to their original shape once the load is removed. The use of elastic fibers is therefore particularly suitable for functional constructions in which a high degree of flexibility or the damping of shock-like loads is desirable.

The use of composite fibers makes it possible for the ligament system to fulfil several different functions simultaneously. For example:
The use of carbon-fiber-core composite fibers improves the tensile strength of the structure and increases longitudinal stiffness, such that subsequent heat treatment or curing may form rigid regions.
Glass-fiber-or aramid-fiber-core (for example Kevlar) structures provide increased impact resistance and thermal stability.
By using composite fibers having a metal core, for example containing copper or aluminum filaments, the ligament system may be implemented so as to be electrically and/or thermally conductive.

The latter option makes it possible, for example, to integrate wiring, sensors, bending sensors or active control elements into the structure of the joint mechanism without the need to incorporate separate wiring. In this case, the braided structure serves not only as a structural carrier for movement and force transmission, but also as an electrical interface for sensing and/or control.

The combined use of different types of fibers makes it possible for the ligament system e.g., ligament system 20, 120, 220, 255, 275, 320, 420, 720, or other ligament system) to exhibit regionally differing mechanical and functional characteristics. Thus, for example, high-modulus or rigid fibers may be used in regions exposed to high loads, while a more elastic fiber composition is used in flexible connection or bending zones. Such a heterogeneous distribution of fiber materials may even be controlled in a programmed manner during the braiding process, in particular when using 3D braiding or over-braiding manufacturing technologies in some embodiments.

According to one embodiment, a joint mechanism (e.g., joint mechanism 10, 100, 200, 300, 250, 270, 400, 700 or other join mechanism) comprises a plurality of ligament systems arranged in layers one above another, each configured as a braided-structure sheath. In other words, a ligament system (ligament system 20, 120, 220, 255, 275, 320, 420, 720, or other ligament system) may in some embodiments comprise a plurality of braided sheaths. The sheaths may preferably have different fiber orientations, braiding patterns or material compositions on a layer-by-layer basis, allowing the mechanical and functional characteristics of the joint mechanism to be optimized on multiple levels. For example, certain sheath layers may serve to guide bending movement, while other layers provide reinforcement against axial shear or torsion. An advantage of the layered configuration is that, for example, inner sheaths may be more flexible and more closely follow the movement of the terminals (e.g., terminals 12, 112, 212, 252, 272, 312, 412, or other terminals) while outer layers may provide structural stability, wear protection or other functional roles, such as sensor support or electrical shielding.

In certain cases, the braided-structure sheaths of a multi-layer ligament structure are arranged as concentric successive layers. In further embodiments, two or more braided-structure sheaths of a multi-layer ligament structure are at least partially braided into one another, for example via common nodes, by changing the braiding pattern while braiding multiple layers in parallel in one manufacturing process, or by overlapping loop formations. As a result, the structure does not merely form a layered arrangement, but rather a coherently integrated unit that is capable of providing complex mechanical responses to applied loads.

In various embodiments, the braided sheath may be formed by maypole braiding, lace braiding, variation braiding, Cartesian braiding, or manual or manually assisted braiding using frames, or other braiding methods. Certain embodiments combine mandrel over-braiding with 3D braiding. Traditional mandrel over-braiding was used to braid a sleeve over a single, static mandrel (e.g., tubes, shells). It produces a uniform shell that passively conforms to mandrel geometry. By itself, it cannot create branches, ligaments, or complex articulated geometry. However, without a mandrel, fibers collapse into a rope-like structure. 3D braiding uses a matrix arrangement rather than a single circular track and allows bifurcation, branching, and re joining of braid paths. It was traditionally used to make networks or bifurcated textile structures-(e.g., nets and beams). However, in a combined method, a mandrel (e.g., scaffold or other mandrel) may be held in a braiding area at or near the center of a 3D braiding system (e.g., a rotational 3D braiding system or other 3D braiding system(and use the 3D system to braid a 3D structure about the mandrel.

Unlike traditional mandrel over-braiding, the 3D braiding system is used, according to embodiments of the present disclosure, to over-braid mandrels that themselves may form articulated joints and moving assemblies, not mere scaffolds for static shells. Embodiments may create ligaments, tendons, joint constraints and other features as part of the same braided structure.

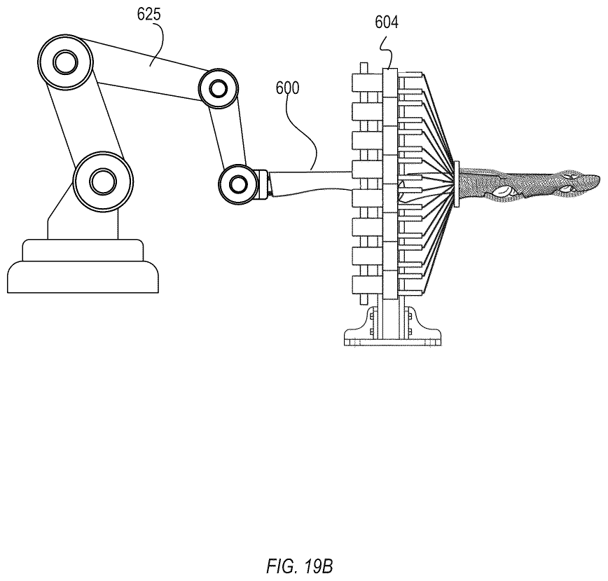

For additional context, FIG. 19A, for example, illustrates one embodiment of a manufacturing process for fabricating ligament system 400 of robotic finger 400. A similar process may be used for other ligament systems. A product scaffolding 600 (e.g., a mandrel) may be created such as by a 3D printer 602, injection molding, or other processes depending on the materials being used to create the terminals. In general, the product scaffolding includes the terminals (e.g., terminal 412a, terminal 412b, terminal 412c, terminal 412d (generally terminals 412) and may include other components to be encapsulated in the braided sheath, such as, but not limited to the cartilage.

The product scaffolding 600 is fixed to a central unit (for example to a jig-fixing mechanism of a 3D braiding machine 604) in the appropriate order and spacing for the joint. The jig may be any appropriate solution that can align and hold the terminals for braiding. According to certain embodiments, the jig structure, whether internal or external to the mandrel, does not become part of the joint mechanism and is not over-braided, but is removed during or after braiding. Thus, the support structure may be removed after the ligament system 420 or at least the portion of the relevant braided structure is over-braided on the mandrel. For example, in a multi-jointed configuration, the support structure may be removed sequentially from a braided joint while the subsequent joint remains supported during its respective braiding.

The product scaffolding may be held together, for example, by one or more wires, an external mechanical jig, robotic arms or other structure (e.g., external structure) in a braiding area 610 while the braid is formed under tension (e.g. robot arms holding the terminals on poles, holding them together while translating them through the braider). Because the braid is formed under tension, the braid will bias the terminals 412 together. Thus, when the braid is sufficiently formed over a terminal, the external structure may stop supporting one or more of the terminals because the tension in the braid and friction will hold the terminals together. For example, when the braid is sufficiently formed over terminal 412a, the tension in the fibers may be sufficient to hold terminal 412a against terminal 412b such that the jig or other external structure can stop supporting terminal 412a. In other embodiments, the terminals may be formed so that they stack vertically and are held together on the jig by gravity.

In some embodiments, a relatively thin internal or external structure may be used to support the mandrel. The jig may, for example, comprise a strong, but flexible strip or wire on which the terminals are positioned, or that is routed along locally concave regions of the mandrel for accepting the jig, or internally (e.g., through aligning longitudinal passages through the terminals). For example, one or more wires 603 may run through the terminals, where the wires can be progressively removed during braiding or after braiding the ligament system is done. In another example embodiment, the terminals may be attached by an adhesive or other mechanism that can be dissolved, melted or otherwise removed after braiding is complete.

FIG. 19A depicts a 3D braiding machine 604 in which braiding heads 606 are carried on horn gears and are moveable between horn gears through switches as is known in the art. The braiding heads can move in complex 2D patterns, while the scaffolding 600 (or terminals) is translated in the third dimension to create a 3D pattern. While the fibers 608 forming the ligament system 420 are guided into position by the mechanism of braiding heads 608 moving along a multi-path closed trajectory. The movement of the braiding heads 608 allows controlled, symmetrical or asymmetrical placement of the fibers 608 over the surface of the scaffolding 600 in a desired pattern. The braiding heads may be arranged opposite one another or at different angles, thereby creating a multi-directional fiber system. The ligament system 420 can be formed under tension to induce pre-tension for fixing the ligament system to one or more of the terminals 412. As further illustrated, the coupling elements 428 created by braiding may be connected to an actuator 450 to drive flexion and extension of the robotic finger 400.

FIG. 19B illustrates, for example, that a robotic arm 625 may hold product scaffolding 600 or other mandrel. The robotic arm 625 guides the mandrel through the center (or any other dedicated region) of a braiding machine 604. Once the ligament system 420 is sufficiently braided, the mandrel may be removed from robotic arm 625 or other support structure, the fiber terminated and other operations to complete the braided structure performed. Other mechanisms known or developed in the art for moving a substrate on which over-braiding is to be performed relative to a braider, such as actuators (e.g., a linear or slide actuator), a movable platform or base, moving the braider, among others which may be employed.

A ligament system (e.g., ligament system 20, 120, 220, 255, 275, 320, 720 or other ligament system) may alternatively be produced as an independent component as well, in accordance with the design intent, for example by a braiding process limited solely to the fibers and other elements of the ligament system, without terminals being present (independent braiding), or by over-braiding around a temporary mandrel (indirect mandrel over-braiding) that is geometrically similar to the terminals or to a certain state of the kinematic chain formed by them (deviations being permissible according to the design intent). The temporary mandrel is subsequently removed (for example by extraction, melting out or dissolution) from the braided-structure sheath, so that the ligament system can be mounted as an independent component, for example by slipping it onto the terminals used in application. In this case as well, the inherent clamping force of the braided structure can be utilized to achieve fixation, although greater emphasis may then be placed on the fixation-supporting effects of additional elements, such as form-fitting connections, loops, clamping sleeves and base bodies.

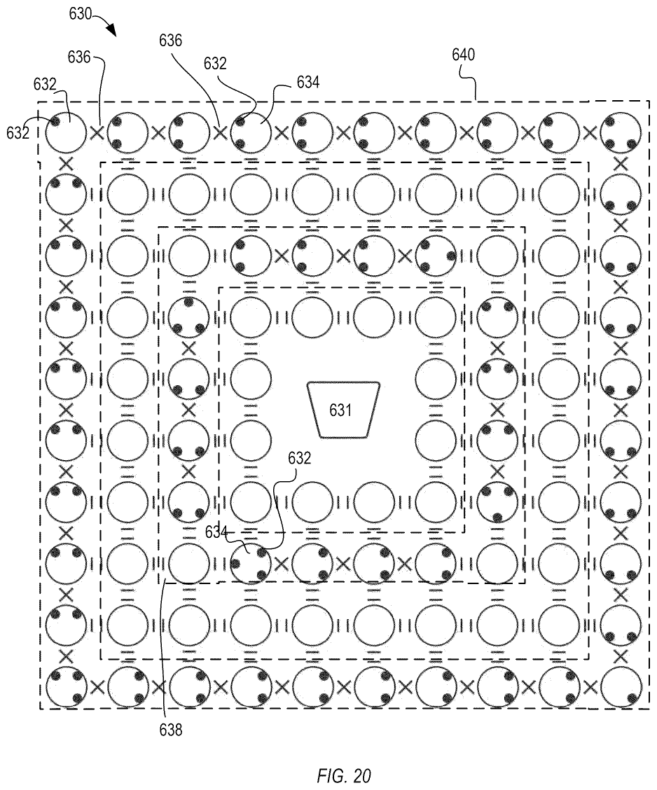

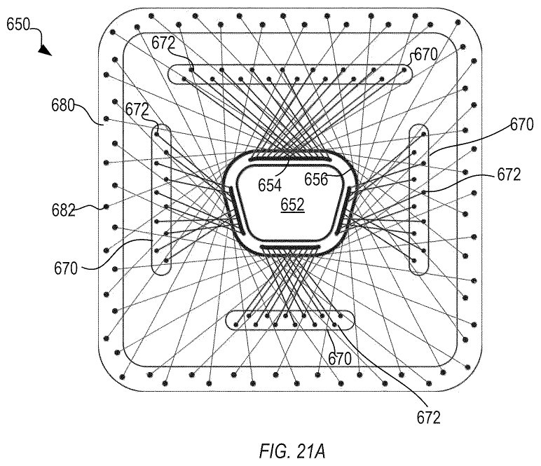

FIG. 20 illustrates one embodiment of a braiding machine 630 for over-braiding on a mandrel 631 consisting of a plurality of terminals. In braiding machine 630, carriers 632 (braiding heads) are carried on horn gears 634 and can transition between adjacent horn gears at switches 636 (only select braiding heads, horn gears and switches are denoted for simplicity). The horn gears, carriers, and switches of the braiding system 630 can be configured to achieve a complex braiding pattern. In the embodiment of FIG. 20, the carriers and horn gears 634 are arranged in an inner layer 638 for braiding an inner layer of a ligament system 420 onto the mandrel 631 and an outer layer 640 for braiding an outer layer of a ligament system 420 onto mandrel 631 encapsulation or partially encapsulating the inner layer as well. By controlling how the horn-gears move carriers 632 in a 2D topology as mandrel 631 is translated, braiding machine 630 can over-braid a 3D pattern onto mandrel 631.

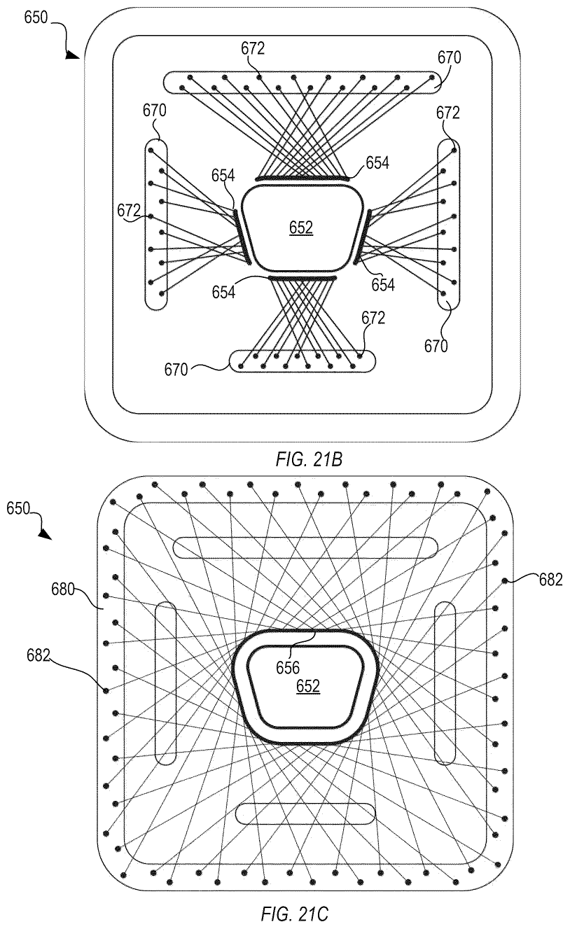

FIG. 21A illustrates one example of a braiding machine 650 to further illustrate over-braiding of fibers according to one embodiment. FIG. 21B illustrates an inner layer braiding portion in more detail and FIG. 21C illustrates an outer layer braiding portion in more detail. The braiding machine 650 braids multiple layers on a mandrel 652 (e.g., a removable mandrel, a sacrificial mandrel, a product scaffolding of terminals). The horn gears and switches are not shown for simplicity. In the illustrated embodiment, the ligament system includes an inner layer 654 and an outer layer 656, which may be similar to as discussed above with respect to FIG. 12, FIG. 15A and FIG. 15B. Though the layers are shown with a gap between the mandrel and inner layer 654 and a gap between layer 654 and layer 656, this is merely to illustrate differentiation between the layers and the layers are braided under tension to be form fitting as discussed above.

Each layer may have a corresponding set of braiding heads where the braiding heads for a layer are moveable in a pattern corresponding to the braiding pattern of the layer. In the illustrated embodiment, the braiding machine includes arranged groups 670 of inner layer braiding heads 672 (only some of which are labeled). In certain embodiments, each group 670 comprises a matrix of horn gears carrying the braiding heads 672. Braiding heads 672 may transition between horn gears at switches.

Similarly, the braiding machine 650 includes an outer layer braiding ring 680 that comprises braiding heads 682. The outer layer braiding ring 680 may similarly comprise a matrix of horn gears carrying the outer layer braiding heads 682. Braiding heads 682 may transition between horn gears at switches.

In this embodiment, as mandrel 652 is translated through braiding machine 650, the positions of braiding heads 672, 682 are controlled to braid the fibers under tension, simultaneously braiding the inner layer 654 and outer layer 656 of the ligament system.

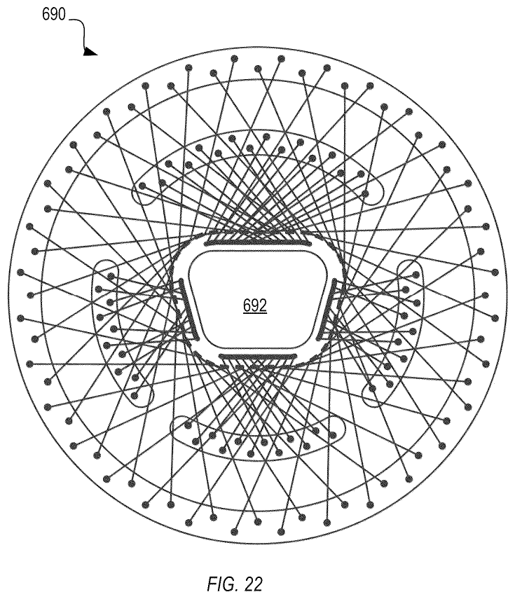

FIG. 22 illustrates another embodiment of a braiding machine 690 over-braiding multiple layers onto a mandrel 692, but in which the braiding heads are arranged in a circular arrangement about the braiding area (again the horn gears and switches are omitted for simplicity).

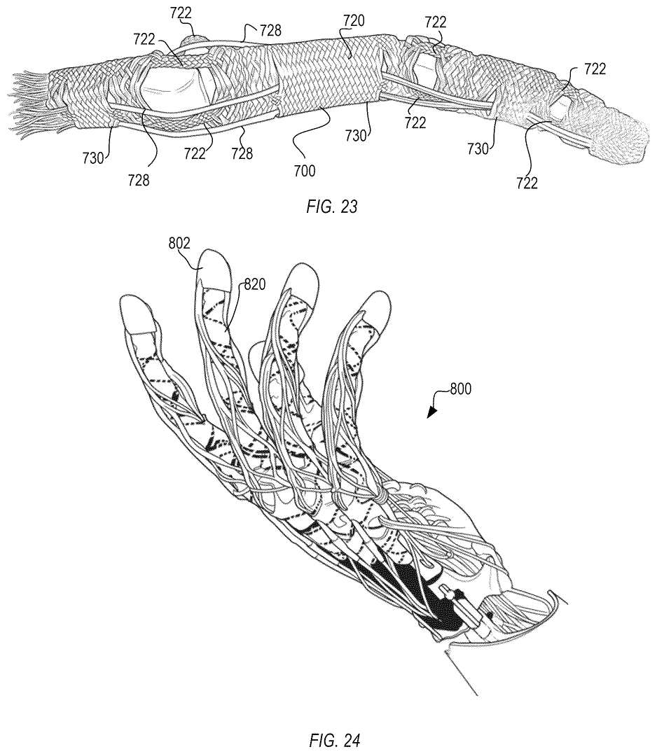

FIG. 23 illustrates an example robotic finger 700 created by over-braiding according to FIG. 19. The robotic finger 700 is similar to robotic finger 400 and includes terminals similar to terminals 412, a ligament system 720 similar to ligament system 420 with ligament portions 722, tendons 728 and guide parts 730 (robotic finger 700 has an additional tendon branch 728). Tendons 728 are braided cables that are braided into each other with the braided sheath as part of the over-braiding operation instead of a separately assembled attachment point. As illustrated in FIG. 24, a robotic hand 800 may be constructed that has fingers configured according to the teachings herein (e.g., each finger may have a respective braided ligament system 820 with tendons and guides configured for that finger). In some embodiments, a cap 802 formed of soft or rigid plastic or other material, which may be a form of base body in some embodiments, may be used to protect the finger tips and, in some embodiments, assist in fixing the ligament system 820 (e.g., the cap may be press fit, screwed-on, or otherwise assert a clamping force on the finger tip), protect the branching point for the tendons, or provide an anchor point for separately fabricated tendons. The hand 800 or its extended frame (e.g. the forearm) may house actuators for independently actuating each finger or joint.

Non-limiting example embodiments include:
a. A joint mechanism comprising at least two terminals adapted to move relative to one another, characterized in that it comprises a ligament system comprising a braided-structure sheath that couples the terminals to one another, wherein the braided-structure sheath circumferentially surrounds a surface of at least one terminal from the plurality of terminals in a sleeve-like manner to establish a mechanical engagement with the surface of at least one terminal by a self-clamping effect of its braided structure to self-secure to the at least one terminal.
b. The joint mechanism of paragraph a, wherein the mechanical engagement comprises a form-fit engagement.
c. The joint mechanism of paragraph b, wherein the form-fit establishes a positive-locking engagement with the surface of the least one terminal.
d. The joint mechanism of any one of paragraphs a-c, wherein the mechanical engagement comprises a friction locking engagement.
e. The joint mechanism of any one of paragraphs a-d, wherein the mechanical engagement self-secures the ligament system to at least one terminal.
f. The joint mechanism according to any one of paragraphs a-e, characterized in that the ligament system is positively locked to a surface of a plurality of terminals by the self-clamping effect of its braided structure.
g. The joint mechanism according to any one of paragraphs a-f, characterized in that at least one terminal is provided with a shaped surface configuration promoting fixation of the ligament system on the at least one terminal.
h. The joint mechanism according to paragraph g, characterized in that the shaped surface configuration comprises a groove, a roughened surface (e.g., a knurled surface or other area with an increased Ra value), or a conical surface.
i. The joint mechanism according to any one of paragraphs a to h, characterized in that an inclination angle of braided fibres of the ligament system is configured to decrease under load and thereby to contract the sheath in a radial direction.
j. The joint mechanism according to any one of paragraphs a to i, characterized in that the ligament system is formed with at least a first region and a second region and wherein the first region has at least one of a different braiding density from the second region, a different braiding pattern for the second region, a different tightness from the second region, a different compactness form the second or region, or fibres of different materials from fibers of the second region.
k. The joint mechanism according to any one of paragraphs a to j, characterized in that the ligament system comprises, in a region allowing displacement between the terminals, a ligament part formed with at least one ligament branch.
l. The joint mechanism according to any one of paragraphs a to k, characterized in that a rigid, flexible or elastic insert influencing the mechanical or functional properties of the ligament system is incorporated into the ligament system.
m. The joint mechanism according to any one of paragraphs a to l, characterized in that the ligament system comprises a coupling element.
n. The joint mechanism according to paragraphs a to m, characterized in that the ligament system comprises at least one of: a guiding part, formed as a loop or a feed-through opening, for enabling passage of a coupling element or a ligament part, wherein the guiding part is integrated into the braided structure of the ligament system; a fixing part for facilitating attachment of an external body.
o. The joint mechanism according to any one of paragraphs i to n, characterized in that the coupling element is configured as a tendon forming part of the ligament system, for relative actuation of the terminals or for coupling the joint mechanism to an external object.
p. The joint mechanism according to any one of paragraphs a to o, characterized in that the ligament system is formed in a single braiding operation by direct or indirect braiding onto the terminals. Alternatively, the braided structure may be formed in multiple operations.
q. The joint mechanism according to any one of paragraphs a to p, characterized in that the ligament system is formed with a biaxial, triaxial or multi-directional braiding geometry.
r. The joint mechanism according to any one of paragraphs a to m, characterized in that the ligament system comprises fibers composed of one or more of a polymeric, a thermoplastic material, an elastomeric material, a metallic material, a mineral-based material, carbon fiber, glass fiber, natural fiber or other material and wherein the fibers comprising at least one of a monofilament fiber or a multifilament fiber.
s. The joint mechanism according to any one of paragraphs a to r, characterized in that the braided ligament system is fixed by means of a fixing element enabling positive-locking fixation to a surface of at least one of the terminals.
t. The joint mechanism according to any one of paragraphs a to s, is characterized in that the ligament system comprises a plurality of layers.
u. The joint mechanism of any one of paragraphs a to t, characterized in that the self-clamping effect of the braided ligament system increases as a function of mechanical load applied to the joint mechanism.
v. The joint mechanism according to any one of paragraphs a to u, wherein the braided structure sheath distributes mechanical loads over an extended surface area of at least one terminal-rather than through discrete point like attachment locations.
w. The joint mechanism according-to any one of paragraphs a to v, characterized in that the ligament system mechanically couples the plurality of terminals without requiring post-fabrication fastening elements, adhesive bonding, or sutures.
x. The joint mechanism according to any one of paragraphs a to w, characterized in that the joint mechanism forms part of a robotic limb, robotic finger, orthotic device, prosthetic device, or a biomechanical manipulator.
y. The joint mechanism according to any one of paragraphs a-x, wherein the at least one terminal ligament system is configured to permit articulation of a joint comprising the at least one terminal
z. The joint mechanism according to paragraph y, wherein each of the at least two terminals are components of the joint.
aa. The joint mechanism of any one of paragraph a-z, wherein the joint is a uniaxial joint having one principal degree of freedom.
ab. The joint mechanism of any one of paragraph y-z wherein the joint is a biaxial joint having two principal degrees of freedom.
ac. The joint mechanism of any one of paragraphs y-z wherein the joint is a multiaxial joint having at least three principal degrees of freedom.
ad. The joint mechanism of any one paragraphs y-ac, wherein the joint exhibits a secondary motion (e.g., constrained arthrokinematic or accessory motion) occurring at the articular interfaces in conjunction with a primary motion.
ae. The joint mechanism of paragraph ad, where the secondary motion is mechanically constrained by at least one of the following: the geometry of articulating members of the joint or the ligament system (e.g., so as to remain within predetermined limits while enabling functional articulation)
af. The joint mechanism of any one of paragraph y-ae, wherein the ligament system permits articulation of the joint within a defined kinematic, wherein the defined kinematic envelope for the joint comprises one or more primary degrees of freedom.
ag. The joint mechanism of paragraph af, wherein the one or more primary degrees of freedom comprises at least one translational degree of freedom.
ah. The joint mechanism of any one of paragraphs af-ag, wherein the one or more primary degrees of freedom comprises at least one rotational degree of freedom.
ai. The joint mechanism of any one of paragraph af-ah, wherein joint is movable according to a motion that emulates a biological joint response or fulfills a specific kinematic requirement.
aj. The joint mechanism of any one of paragraphs y-ai, wherein the joint comprises a biomimetic architecture that mimics biological behavior, where joint comprises a plurality of interconnected structural links configured to approximate the physiological kinematics and degrees of freedom of a biological human joint and wherein the ligament system mimics the kinematic constraints of biological ligaments to manage joint stability, limit undesirable ranges of motion or facilitate force distribution across terminal surfaces.
ak. The joint mechanism of any one of paragraphs y-aj, wherein the joint mechanism is adapted to perform at least one of the following: flexion/extension, abduction/adduction, lateral translation, longitudinal translation, or rotation.
al. The joint mechanism of paragraph ak, wherein the lateral translation comprises at least one of anterior-posterior translation or lateral-medial translation.
am. The joint mechanism of any one paragraphs a-al, wherein the braided structure of the ligament system comprises fibers composed of at least one of a polymeric material; a thermoplastic material, an elastomeric material; a metallic material; a mineral-based material; carbon fiber; glass fiber; or natural fiber.
an. The joint mechanism of any one of paragraphs a-am, wherein the braided structure of the ligament system comprises at least one of a monofilament fiber or a multifilament fiber.
ao. The joint mechanism of any one of paragraphs a-ao, further comprising at least one clamping ring or other auxiliary element to provide auxiliary fixation.
ap. The joint mechanism of any one of paragraph a-ao, wherein the ligament system comprises at least one fixing element, wherein each fixing element engages into a fixing cavity to enhance a positive locking fixation between the ligament system and one or more of the terminals.
aq. The joint mechanism of any one of paragraph a-ap, wherein the self-clamping effect causes the braided structure of the ligament system to conform to surface contours of one or more the terminals to establish a positive lock between the ligament system and the one or more terminals.
ar. The joint mechanism of any one of paragraphs a-aq, wherein the ligament system comprises one or more integrated sensors.
as. The joint mechanism of any one of paragraphs a-ar, wherein the ligament system is adapted to assert a coaptive force to resist distraction of two or more of the terminals.
at. The joint mechanism of any one of paragraphs a-as, wherein the joint comprises one or more of a rotational contact, a rolling contact, a sliding contact, or a translational contact.
au. The joint mechanism of paragraph at, wherein the ligament system has a preload and is adapted to assert the coaptive force when the joint mechanism is unloaded.
av. The joint mechanism of any one of paragraphs a-au, wherein the ligament system comprises one or more integrated actuators.
ax. An articulating structure comprising a joint mechanism according to any one of paragraphs a-au.
ay. An articulating structure according to paragraph ax, wherein the articulating structure is non-actuated.
az. An articulating structure according to paragraph ax, wherein the articulating structure is actuated.
ba. An articulating structure according to paragraph az, wherein the ligament system comprises one or more integrated actuators.
bb. A method of manufacturing a joint mechanism according to any one of paragraphs a to av or an articulating structure according to any one of paragraphs ax-ba characterized in that it comprises three-dimensionally over-braiding the ligament system onto the terminals.

The embodiments described above are intended to be exemplary and not mutually exclusive. It is to be understood that technical features described in one embodiment can be mixed and matched with technical features of other embodiments without departing from the spirit or scope of the invention. The absence of a specific description of a combined embodiment does not preclude its support under this disclosure, provided the combination remains functionally viable.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus. Further, unless expressly stated to the contrary, “or” refers to an inclusive “or” and not to an exclusive “or”. The use of the term “and/or” in certain instances within this specification or the following claims is intended for emphasis and shall not be construed to imply that the use of the term “or” elsewhere is limited to an exclusive ‘either/or’ meaning. Accordingly, a condition “A or B” is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like. Furthermore, any dimensions, materials or other such characteristics are provided by way of example and not limitation.

It is clear that a person skilled in the art may envisage other alternative solutions compared to the embodiments presented herein, which nevertheless fall within the scope of protection as defined by the claims.

What is claimed is:

1. A joint mechanism comprising:
providing a mandrel comprising a plurality of terminals; and
a ligament system comprising a braided-structure sheath that couples the terminals to one another, wherein the braided-structure sheath mechanically engages with the surface of the at least one terminal by a self-clamping effect to self-secure to the at least one terminal.

2. The joint mechanism according to claim 1, wherein the mechanical engagement comprises at least one of a positively locking form fit or a friction fit.

3. The joint mechanism according to claim 1, wherein the ligament system is positively locked to each of the plurality of terminals by the self-clamping effect of its braided structure.

4. The joint mechanism according to claim 1, wherein at least one terminal of the plurality of terminals is provided with a shaped surface configuration promoting fixation of the ligament system on the at least one terminal.

5. The joint mechanism according to claim 4, wherein the shaped surface configuration comprises a groove, an area of increased roughness, or a conical surface.

6. The joint mechanism according to claim 1, wherein an inclination angle of braided fibres of the ligament system decreases under load to thereby contract the braided-structure sheath in a radial direction.

7. The joint mechanism of claim 1, wherein the ligament system comprises a first region and a second region, wherein the first region has at least one of: a different braiding density from the second region, a different fiber pattern from the second region, a different compactness from the second region, or fibres of different materials from fibers of the second region.

8. The joint mechanism according to claim 1, wherein the ligament system comprises, in a region allowing displacement between the terminals, a ligament part formed with at least one ligament branch.

9. The joint mechanism according to claim 1, comprising a rigid, flexible or elastic insert incorporated into the ligament system, wherein the insert influences a mechanical or functional property of the ligament system.

10. The joint mechanism according to claim 1, wherein the ligament system comprises at least one guiding part, formed as a loop or a feed-through opening, for enabling passage of a coupling element or a ligament part, wherein the at least one guiding part is integrated into the braided structure of the ligament system.

11. The joint mechanism according to claim 10, wherein the coupling element is configured as a tendon forming part of the ligament system, for relative actuation of the plurality of terminals or for coupling the joint mechanism to an external object.

12. The joint mechanism of claim 1, wherein the ligament system comprises at least one fixation part to which an external component formed separately from the braided structure is attached.

13. The joint mechanism of claim 1, wherein the ligament system is formed in a single braiding operation by direct or indirect braiding onto the terminals.

14. The joint mechanism according to claim 1, wherein the ligament system is formed with a biaxial, triaxial or multi-directional braiding geometry.

15. The joint mechanism according to claim 1, wherein the mechanical engagement establishes a positive locking fixation with a first terminal from the plurality of terminals, wherein the first terminal includes a fixing cavity formed in the first terminal and wherein the ligament system comprise a fixing element received in the fixing cavity that supplements the positive locking fixation.

16. The joint mechanism according to claim 1, wherein the ligament system is a multi-layered ligament system.

17. The joint mechanism according to claim 1, wherein the self-clamping effect of the braided ligament system increases as a function of mechanical load applied to the joint mechanism.

18. The joint mechanism according to claim 1, wherein the joint comprises a biomimetic architecture.

19. The joint mechanism according to claim 1, wherein the braided-structure sheath distributes mechanical loads over an extended surface area of the at least one terminal rather than through discrete point-like attachment locations.

20. An articulating structure comprising:
a plurality of terminals arranged to form at least one joint; and
a braided textile ligament system surrounding and engaging through a self-clamping, multiple terminals of the plurality terminals, wherein the ligament system distributes mechanical loads across surface areas of the multiple terminals and constrains relative movement between the plurality of terminals while permitting articulation at the at least one joint.
